(19) United States
(12) Patent Application Publication
(10) Pub. No.: US 2022/0368409 A1
(43) Pub. Date: Nov. 17, 2022

(54) Solar System Multi-Band, Mesh Networking Data Relay Apparatus

(71) Applicant: Matthew Joseph Harris, Runnemede, NJ (US)

(72) Inventor: Matthew Joseph Harris, Runnemede, NJ (US)

(21) Appl. No.: 17/249,615

(22) Filed: Mar. 7, 2021

(51) Int. Cl. H04B 7/185; H04W 40/22

(52) U.S. Cl. CPC H04B 7/1851; H04W 40/22; H04B 7/18521; H04W 84/18

(57) ABSTRACT

A Data Relay Apparatus comprising multiple Systems of Data Relay Devices operating interconnectedly to provide data information transmissions throughout the Solar System. The Data Relay Apparatus provides multi-band radio frequency and optical laser-based data transmission across a Mesh Network located at calculated orbital positions/paths and celestial bodies in the Solar System region. Data Processing Hardware determines communications paths to route data information from transmission to destination Data Relay Devices. The determination of Signal Destination Routes creates, sustains, and enables a self-forming, self-healing, and self-expanding, respectively, Mesh Network configuration and characteristic of the Data Relay Apparatus. The location of Data Relay Devices enables data information connectivity from the orbital paths of Venus to Neptune. The invention improves existing yet limited data information transmission by providing increased data transmission speed, enhanced capacity, and adaptable network configuration essential to proliferated spacecraft travel and operations throughout the Solar System region.

### REFERENCES CITED

### U.S. Patent Documents

U.S. Pat. No. 4,456,988 Jun. 26, 1984 Nakagome et al.
U.S. Pat. No. 5,966,658 Oct. 12, 1999 Kennedy, III, et al.
U.S. Pat. No. 6,295,294 Sep. 25, 2001 Odlyzko
U.S. Pat. No. 6,745,036 Jun. 1, 2004 Dunne, et al.
2006/0075467 Apr. 6, 2006 Sanda, Frank Seiji; et al.
2007/0081514 Apr. 12, 2007 Shirokura, Yoshihiko
2008/0062934 Mar. 13, 2008 Zhao, Wen
2009/0025677 Sep. 10, 2009 Williams, Christopher Pierce
2016/0044537 Feb. 11, 2016 Macias, et al.
U.S. Pat. No. 9,647,749 May 9, 2017 Krebs
U.S. Pat. No. 10,020,558 Jul. 10, 2018 Sanner, et al.
U.S. Pat. No. 10,826,994 Nov. 3, 2020 Frigo, et al.
U.S. Pat. No. 10,849,047 Nov. 24, 2020 Maruta, et al.
2021/0013975 Jan. 14, 2021 Jacquet et al.
U.S. Pat. No. 10,917,840 Feb. 9, 2021 Boss, et al.

### Other References

Alhilal, Ahmad, Pan Hui, and Tristan Braud, “The Sky is NOT the Limit Anymore: Future Architecture of the Interplanetary Internet,” IEEE Aerospace and Electronic Systems Magazine, Vol. 34, No. 8 (August 2019).
Cerf, V. G., “An Interplanetary Internet,” Space Operations Communicator, Vol. 5, No. 4 (October-December 2008).
Chahat, Nacer, Richard E. Hodges, Jonathan Sauder, Mark Thomson, Yahya Rahmat-Samii, “The Deep-Space Network Telecommunication CubeSat Antenna: Using the deployable Ka-band mesh reflector antenna,” IEEE Antennas and Propagation Magazine, Vol. 59, No. 2 (April 2017).
Edwards, Jr., Charles D., David J. Bell, Abhijit Biswas, Kar-Ming Cheung, Robert E. Lock, “Proximity Link Design and Performance Options for a Mars Areostationary Relay Satellite,” IEEE Aerospace Conference (March 2016).
Greenspan, Thomas, “Stability of the Lagrange Points, L4 and L5,” Thesis paper, Cornell University (January 2014).
Lazio, Joseph, and Les Deutsch, “The Deep Space Network at 50,” Physics Today, Vol. 67(12), 31 (2014).
Luczyk, Justin, “Laser Communications: Capabilities and CONOPs for the Warfighter,” 34^{th} Space Symposium (April 2018).
Rahman, Miftahur, Monirul Islam, and Rashedul Huq, “Deep Space Communication and Exploration of Solar System through Inter-Lagrangian Data Relay Satellite Constellation,” 8^{th} Interplanetary CubeSat Workshop (2019).
Ross, Shane D., “Near-Earth Asteroid Mining,” Space Industry Report (December 2001).
Staehle, Robert L., Diana Blaney, Hamid Hemmati, Dayton Jones, Andrew Klesh, Paulett Liewer, Joseph Lazio, Martin Wen-Yu Lo, Pantazis Mouroulis, Neil Murphy, Paula J. Pingree, Thor Wilson, Brian Anderson, C. Channing Clow II, Bruce Betts, Louis Freidman, Jordi Puig-Suari, Austin Williams, and Tomas Svitek, “Interplanetary CubeSates: Opening the Solar System to a Broad Community at Lower Cost,” Journal of Small Satellites, Vol. 2, No. 1 (2012).
Wan, Peng, and Yafeng Zhan, “A Structured Solar System Satellite Relay Constellation Network Topology Design for Earth-Mars Deep Space Communications,” International Journal of Satellite Communications and Networking, Vol. 37, No. 3 (May/June 2019).

### FIELD OF THE INVENTION

The invention relates generally to networks and network nodes, and more particularly to Outer Space-based electromagnetic wave data information transmission in a self-forming, self-healing, and self-expanding mesh network configuration.

### BACKGROUND

The need for a robust and expandable Data Relay Apparatus is paramount to maintain continuous communication and data information transmission during the proliferation of spacecraft travelling and operations taking place in the Solar System region. At present, the Solar System region does not have established, integrated network links and infrastructure to support proliferated and continuous spacecraft travel and/or operations in this region. The current transit time of interplanetary communications, which utilize Direct-to-Earth technology, can be reduced with an integrated network. The incorporation of multiple communication paths into a network can enhance robustness in the event of future contingencies and enable further expansion of the network as the proliferation of spacecraft travel and operations in the Solar System region increases. A multi-path communications network provides increased data transfer rates and the size of data packets while reducing electromagnetic wavelength propagation across the large distances associated with traveling and operating in the Solar System region. The incorporation of Multi-Band capable transceivers with Data Processing Hardware and Mesh Network capabilities will support continuous communications and data transmission and receiving for transiting spacecraft and operations in the Solar System region.

### BRIEF DESCRIPTION OF THE DRAWINGS

FIG. 1 is a diagram illustrating an example of a configuration of a Data Relay Apparatus according to the embodiment.

FIG. 2 is a diagram illustrating an example of function blocks of a Data Relay Device 10 according to the embodiment.

FIG. 3 is a diagram illustrating an example of function blocks of a Control Device 20 according to the embodiment.

FIG. 4 is a diagram illustrating an example of function blocks of a Terminal 30 according to the embodiment.

FIG. 5 is a diagram illustrating an example of function blocks of a Server 40 according to the embodiment.

FIG. 6 is a diagram illustrating an example of function blocks of Terminal 50 according to the embodiment.

FIG. 7 is a diagram illustrating an example of a hardware configuration of Data Processing Hardware 80 according to the embodiment.

FIG. 8 is a sequence chart illustrating an example of an operation sequence when communications/data information transports between Data Relay Devices within the Data Relay Apparatus according to the embodiment.

FIG. 9 is a schematic of the functional abstraction layers provided by the Data Relay Apparatus according to the embodiment.

FIG. 10 is a block diagram depicting exemplary Functional Components 200 according to various mechanisms of the embodiment.

FIG. 11 is a block diagram depicting a Method 300 for selecting a Data Relay Device in a Data Relay Apparatus by a processor, in which various aspects of the embodiment may be implemented.

FIG. 12 is a flow chart depicting a Method 400 for selecting a Data Relay Device in a network by a processor, in which various aspects of the embodiment may be implemented.

FIG. 13 is a schematic of a situation in which it may be desirable to provide dynamically generated Signal Destination Route priorities according to the embodiment.

FIG. 14 is a block diagram depicting Signal Destination Route determination example Environment 500 according to the embodiment.

FIG. 15 is a block diagram depicting functional components of SIB Engine 512 in accordance with some implementations of the embodiment.

FIG. 16 is a block diagram depicting Process 700 for generating a SIB based on analytics information associated with a System of Data Relay Devices by a SIB Engine 512.

FIG. 17 is a Flowchart 800 illustrating a process for self-forming Mesh Network of Data Relay Devices according to the embodiment.

FIG. 18 is a Flowchart 900 illustrating a process for a self-healing Mesh Network of Data Relay Devices according to the embodiment.

FIG. 19 is a Flowchart 1000 illustrating a process for expanding a Mesh Network according to the embodiment.

FIG. 20 is a diagram of an Earth Ground-to-GEO Data Relay System and Links according to the embodiment.

FIG. 21 is a diagram of the GEO-to-Earth-Moon Lagrangian points L3, L4 and L5 Data Relay Systems and Links according to the embodiment.

FIG. 22 is a diagram of the Earth-Moon Lagrangian points L3, L4 and L5-to-Sun-Earth Lagrangian points L4 and L5 Data Relay Systems and Links according to the embodiment.

FIG. 23 is a diagram of the Earth-Moon Lagrangian points L3, L4 and L5-to-AEO points Data Relay Systems and Links according to the embodiment.

FIG. 24 is a schematic view of an exemplary Solar System-scale Data Relay Apparatus with Data Relay Devices, Systems of Data Relay Devices, and Links according to the embodiment.

### DESCRIPTION OF EMBODIMENTS

### Mode for Carrying Out the Invention

An embodiment of the present invention will hereinafter be described with reference to the drawings. A configuration of the embodiment is an exemplification, and a configuration of the invention is not limited to a specific configuration of the embodiment of the disclosure. A specific configuration corresponding to the embodiment may be properly adopted on the occasion of carrying out the invention.

### DETAILED DESCRIPTION

### Apparatus Configuration

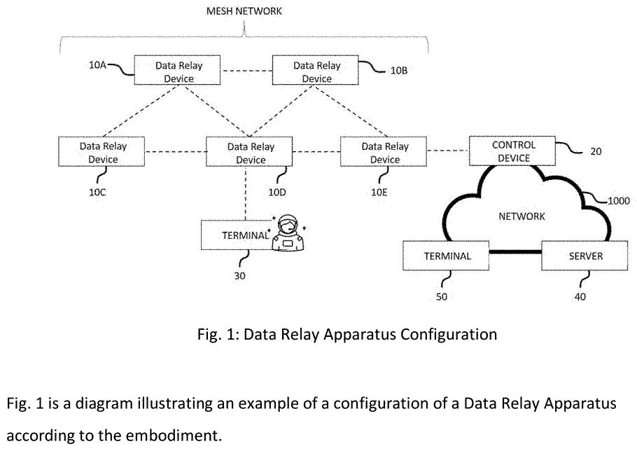

FIG. 1 is a diagram illustrating an example of a configuration of a Data Relay Apparatus according to the embodiment. Note that an electromagnetic wavelength whether in the form of a radio frequency (“RF”) or laser optical signal transmitted and received and a transmitting component and a receiving component of the Data Relay Apparatus will each be called a “Data Relay Device” in the embodiment. The Data Relay Apparatus according to the embodiment includes Data Relay Devices 10A through 10E, Control Device 20, Terminal 30, Server 40, and Terminal 50 in FIG. 1. The Terminal 30 exists in a receivable position of a communication path from any one of the Data Relay Devices 10. The Terminal 30 is, e.g., carried by a spacecraft or attached to a predetermined object such as a facility on a celestial body. The Control Device 20, the Server 40 and the Terminal 50 are interconnected via a Network 60 instanced by the Data Relay Apparatus. The Terminal 30 may also be connected to the Network 1000. The Data Relay Devices 10A through 10E configure a Mesh Network located throughout the Solar System region as part of the Data Relay Apparatus.

The Data Relay Device 10 transmits an electromagnetic wavelength that contains communications and/or data information. The Data Relay Device 10 according to the embodiment has a function of performing mutual communications with other Data Relay Device(s) 10 installed within a reachable distance of electromagnetic wavelengths, thus configuring the Mesh Network. The Data Relay Device 10 receives the communications and/or data information of the Terminal 30 from this Terminal 30. The Data Relay Device 10 transmits, to other Data Relay Device(s) 10, the communications and/or data information of the Data Relay Device 10 itself together with the communications and/or data information received from the Terminal 30. Note that the plurality of Data Relay Devices enabled to perform the communications with each other is generally called a “System.” FIG. 1 depicts the five Data Relay Devices 10, and a number of the Data Relay Devices 10 is not, however, limited to “5.” The Data Relay Device 10 includes, e.g., Multi-Band Transceiver/Transceiver Array and Data Processing Hardware, and attains a variety of functions by getting these components to cooperate with each other.

The Control Device 20 is a device that unitarily controls operations of the plurality of Data Relay Devices 10. The Control Device 20 transmits, to the peripheral Data Relay Devices 10, specifying information containing the data information for communication with any one of the plurality of Data Relay Devices 10 and predetermined items of information. On the other hand, the Data Relay Device 10 transmits the received data information to the peripheral Data Relay Devices 10 and, when receiving the specifying information containing the data information that identifies the Data Relay Device 10 itself, executes a predetermined process based on the communication and/or data information.

The Control Device 20 operates as a Gateway for establishing a connection between the System of Data Relay Device(s) and the Data Relay Apparatus (network) 1000.

The Terminal 30 receives the data information from the Data Relay Device 10. The Terminal 30 transmits the data information itself to the Data Relay Device 10. FIG. 1 depicts one Terminal, and a number of Terminals 30 is not, however, limited to “1”. The Terminal 30 may have a function as the Data Relay Device 10. For example, the Terminal 30 may function as one of the Data Relay Devices 10 within the System of Data Relay Device(s). The Terminal 30 is carried by a spacecraft or attached to a predetermined object such as a facility located on a celestial body.

The Server 40 acquires, from the Terminal 30 via the Data Relay Apparatus, a set of transmission data information contained in the Data Relay Device(s), the reception data information of the spacecraft or facilities in the Terminal 30 and the identifying information of the Terminal 30. The Server 40 outputs the acquired information via the Network 1000 to the Terminal 50 and other equivalent terminals. Note that the Server 40 may also output information corresponding to the Terminal 30.

The Terminal 50 is connected to the Data Relay Apparatus (network) 1000 and receives the information and other equivalent items of the Terminal 30 from the Server 40. FIG. 1 illustrates one Terminal 50, and a number of the Terminals 50 is not, however, limited to “1”.

«Functional Configuration of Data Relay Device 10»

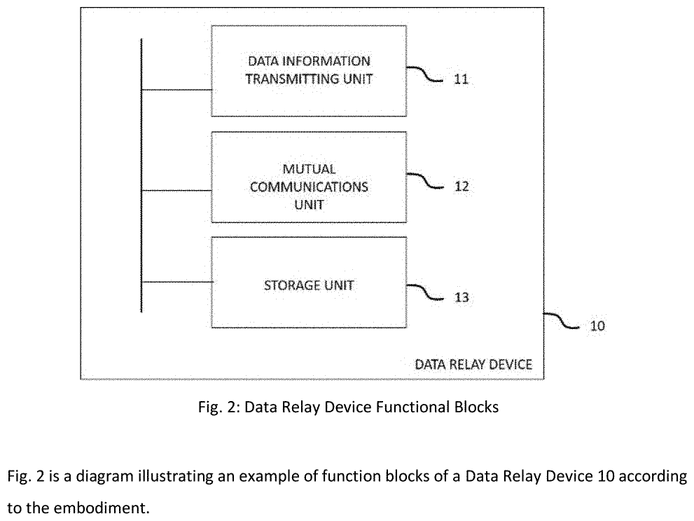

FIG. 2 is a diagram illustrating an example of function blocks of the Data Relay Device 10 according to the embodiment. The Data Relay Device 10 includes a Data Information Transmitting Unit 11, a Mutual Communication Unit 12, and a Storage Unit 13.

The Data Information Transmitting Unit 11 transmits, based on the information retained in the Storage Unit 13, the transmitter/receiver containing the data information for identifying the Data Relay Device 10.

The Mutual Communication Unit 12 transmits and receives the information bidirectionally to and from the other Data Relay Devices 10, the Terminal 30 and the Control device 20. The Mutual Communication Unit 12 may also perform connection-oriented communications. The Mutual Communication Unit 12, when receiving the data information from other Data Relay Devices 10, relays the data information to the peripheral Data Relay Devices 10. On the other hand, when receiving the data information, the Mutual Communication Unit 12 stores the data information in the Storage Unit 13, and executes a predetermined process based on the data information. The Mutual Communication Unit 12 receives from the Terminal 30 a signal containing the terminal ID of the Terminal 30. The Mutual Communication Unit 12 measures reception strength of the received signal. The Mutual Communication Unit 12 stores information contained in the received signal and the signal reception strength in the Storage Unit 13 by being associated with each other.

The Mutual Communication Unit 12 may, in response to a request given from the Control Device 20, give a response of the information retained in the Storage Unit 13 to the Control Device 20 via the Data Relay Apparatus. Unique data information may be previously allocated to the information instanced by the data information transmitted and received between the Data Relay Devices 10. Here at, the Mutual Communication Unit 12 stores the identifying information of the once-transferred information in the Storage Unit 13, then checks, when transferring the information, whether the data information of the information concerned is coincident with the data information of the information transferred in the past to the Storage Unit 13, and may not transfer the information concerned when being the information transferred in the past. It is thereby feasible to avoid a continuous transfer of the same information within the data relay apparatus.

The Storage Unit 13, which is a nonvolatile memory, is attained by, e.g., an Electrically Erasable Programmable Read-Only Memory (EEPROM) instanced by a flash memory possessed by the Data Processing Hardware. The Storage Unit 13 stores the identifying information of the predetermined Data Relay Devices 10 and a setting value of strength of the electromagnetic waves whether RF or optical laser when the Transmitting Unit 11 transmits the data information. The Storage Unit 13 stores the information contained in the received signal and the signal reception strength.

«Functional Configuration of Control Device 20»

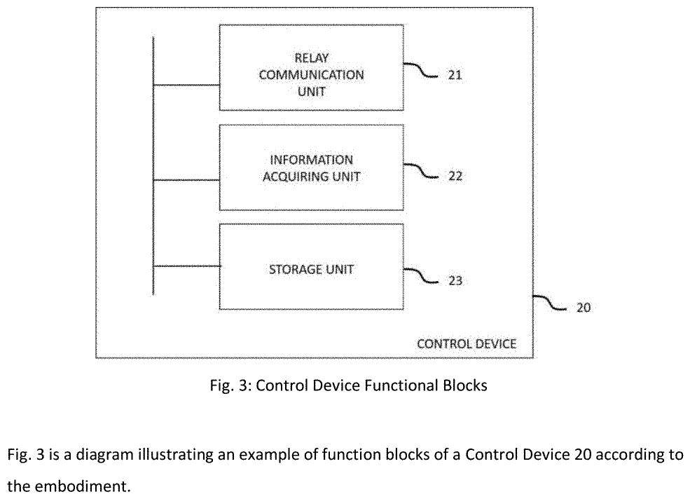

FIG. 3 is a diagram illustrating an example of function blocks of the Control Device 20 according to the embodiment. The Control Device 20, which is, e.g., a general type of computer, includes a Relay Communication Unit 21, Information Acquiring Unit 22, and a Storage Unit 23. The Relay Communication Unit 21 performs the bidirectional communications with the Data Relay Device 10. To be specific, the Relay Communication Unit 21 transmits the specifying information described above, and receives data information from the Data Relay Device 10 and the information retained by the Data Relay Device 10. The Control Device 20 may also be connected to one Data Relay Device 10 by a cable and other equivalent methods in a communication-enabled manner.

The Information Acquiring Unit 22 acquires predetermined information from an unillustrated device via the Network 1000. The Information Acquiring Unit 22 causes, based on an input from the user operating the Control Device 20, the Relay Communication Unit 21 to transmit the data information and to the Data Relay Device 10. The Information Acquiring Unit 22 may acquire the information from the respective Data Relay Devices 10. The Data Relay Device may also send the same data information only once by the broadcast and/or backhaul communication in such a way that the specifying information contains pieces of identifying information associated with all of the Data Relay Devices 10. The data information is configured to contain a hop count indicating how many times the data information is transferred on the Mesh Network, then the Data Relay Device 10 increments the hop count each instance a data information is transmitted, and the specifying information transferred between the Data Relay Devices 10 by a predetermined number of times may be deleted from on the Data Relay Apparatus.

The Storage Unit 23 is attained by, e.g., a Hard Disk Drive (HDD), an Solid State Drive (SDD), the flash memory and other equivalent storages. The Storage Unit 13 stores pieces of positional information indicating the geographical and/or functional locations of the plurality of Data Relay Devices 10, operation settings and other equivalent items by being associated with identifying information (Data Relay Device IDs) of the respective Data Relay Devices.

«Functional Configuration of Terminal 30»

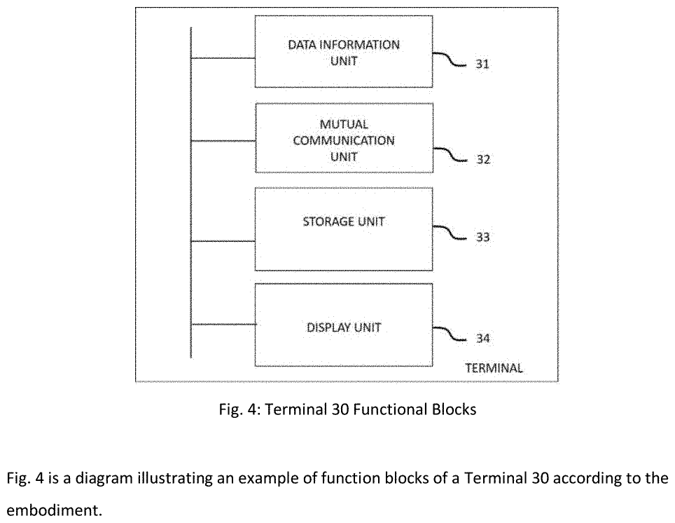

FIG. 4 is a diagram illustrating an example of function blocks of the Terminal 30 according to the embodiment. The Terminal 30, which is instanced by a computer, includes a Data Information Transmitting Unit 31, a Mutual Communication Unit 32, a Storage Unit 33, and a Display Unit 34. Note that the Data Information Transmitting Unit 31 and the Mutual Communication Unit 32 are attained based on application software (also called a “Program”) installed in, e.g., the Terminal 30 by utilizing the communication function of the Terminal 30.

The Data Information Transmitting Unit 31 transmits, based on the information retained in the Storage Unit 33, the data information containing the data information for the Terminal 30 as the Data Relay Device 10. The data information transmitted by the Terminal 30 is receivable by the plurality of Data Relay Devices.

The Mutual Communication Unit 32 transmits and receives the information bidirectionally to and from other Data Relay Devices 10, the Terminal 30, and the Control Device 20. The Mutual Communication Unit 32 may perform connection-oriented communication. The Mutual Communication Unit 32, when receiving the specifying information containing pieces of identifying information of other Data Relay Devices 10, relays the specifying information to the peripheral Data Relay Devices 10. On the other hand, when receiving the specifying information containing the identifying information identifying the Mutual Communication Unit 32 itself, the Mutual Communication Unit 32 stores the specifying information in the Storage Unit 33, and executes a predetermined process based on the specifying information. The Mutual Communication Unit 32 may, in response to a request given from the Control Device 20, give a response of the information retained in the Storage Unit 33 to the Control Device 20 via the Data Relay Apparatus.

The Mutual Communication Unit 32 receives the data information transmitted by the Data Relay Device 10, and stores the received data information in the Storage Unit 33. The Storage Unit 33 is a volatile memory or the nonvolatile memory. For instance, the Storage Unit 33 is attained by the RAM, the ROM and the EEPROM like the flash memory. The Mutual Communication Unit 32 transmits, to the Server 40 via the Data Relay Apparatus, the data information stored in the Storage Unit 33, the reception day/time of the data information and the identifying information for specifying the Terminal 30. Note that the identifying information for specifying the Terminal 30 may involve using an ID provided by an operating system (OS) of the terminal and other equivalent devices, and the Server 40 may also issue unique identifying information to the application software of the Terminal 30.

The Storage Unit 33 is attained by, e.g., the HDD, the SDD, the flash memory and other equivalent storages. The Storage Unit 33 stores the identifying information for identifying the Terminal 30, which is sent from the Terminal 30. The Storage Unit 33 stores pieces of positional information indicating the geographical and/or functional locations of the plurality of Data Relay Devices 10 by being associated with the identifying information (Data Relay Device IDs) of the respective Data Relay Devices.

The Display Unit 34 displays the positional information and other items of information stored in the Storage Unit 33 on a monitor provided in the Terminal 30.

«Functional Configuration of Server 40»

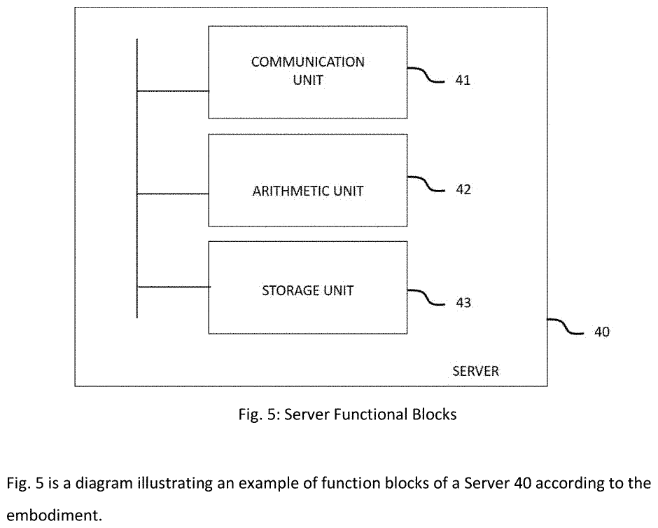

FIG. 5 is a diagram illustrating an example of function blocks of an information providing Server 40 according to the embodiment. The Server 40, which is, e.g., a desktop computer, includes a Communication Unit 41, an Arithmetic Unit 42 and a Storage Unit 43. The Control Device 20 and the Server 40 may be configured integrally to operate as one control device.

The Communication Unit 41 transmits and receives the information to and from the Control Device 20 and the Terminal 50 via the Network 1000. As described above, the Communication Unit 41 receives the information containing the identifying information of the Terminal 30 from the Terminal 30 via the Data Relay Apparatus and the Control Device 20, and stores the received information in the Storage Unit 43.

The Arithmetic Unit 42 performs a predetermined arithmetic operation, based on the information given from the Data Relay Device 10 and the Terminal 30. The Arithmetic Unit 42 calculates an existing position of, e.g., the Terminal 30.

The Storage Unit 43, which is configured by, e.g., the HDD, the SDD or the flash memory, stores the information received from the Terminal 30 via the Data Relay Apparatus and the Control Device 20 and the information indicating the position, calculated based on the received information, of the Terminal 30, and may previously store, in addition to these items of information, information on the periphery of the position in which the Data Relay Device 10 is installed. The Storage Unit 43 stores the identifying information (Data Relay Device IDs) of the Data Relay Devices 10 configuring the Data Relay Apparatus and the positional information indicating the existing positions of the Data Relay Devices by being associated with each other.

«Functional Configuration of Terminal 50»

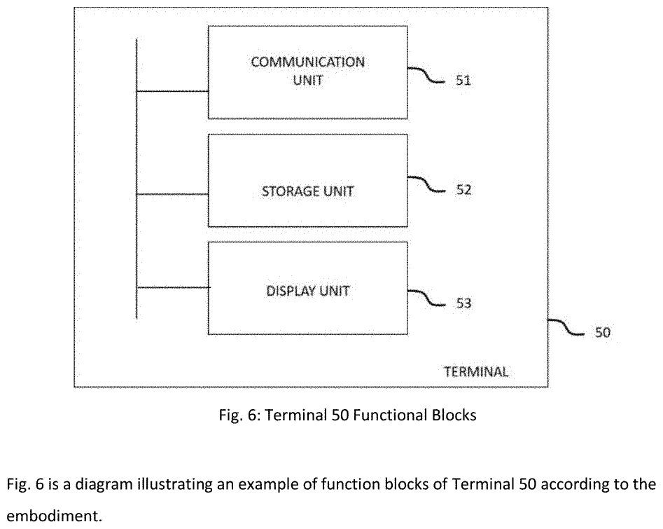

FIG. 6 is a diagram illustrating an example of function blocks of the Terminal 50 according to the embodiment. The Terminal 50, which is, e.g., the computer, includes a Communication Unit 51, a Storage Unit 52, and a Display Unit 53.

The Communication Unit 51 transmits and receives the information to and from the Server 40 via the Network 1000. As described above, the Communication Unit 51 receives the information containing the positional information of the Terminal 30 from the Server 40, and stores the received information in the Storage Unit 52.

The Storage Unit 52, which is configured by the HDD, the SDD or the flash memory, stores the information received from the Server 40. The Storage Unit 52 stores the positional information, received from the Server 40, of the Terminal 30. The Storage Unit 52 may store a map covering an area (positional coordinates of Solar System and other equivalent areas) in which the Data Relay Devices 10 configuring the Data Relay Apparatus are installed.

The Display Unit 53 displays the positional information, stored in the Storage Unit 52, of the Terminal 30 and other items of information on the monitor provided in the Terminal 50.

«Functional Configuration of Data Processing Hardware 80»

The Control Device 20, the Terminal 30, and the Terminal 50 are each attainable by using a dedicated or general-purpose computer instanced by electronic equipment mounted with the computer. The Server 40 is attainable by using the dedicated or general-purpose computer instanced by the computer and a Workstation, or the electronic equipment mounted with the computer.

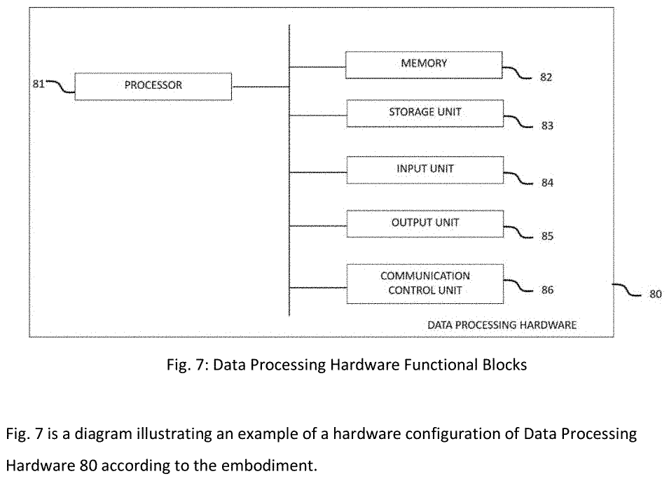

FIG. 7 is a diagram illustrating an example of a configuration of a Data Processing Hardware according to the embodiment. A Data Processing Hardware 80 illustrated in FIG. 7 has a configuration of the general type of computer. The Control Device 20, the Terminal 30, the Server 40 and the Terminal 50 are each attained by the Data Processing Hardware 80 as depicted in FIG. 7. The Data Processing Hardware 80 includes a Processor 81, a Memory 82, a Storage Unit 83, and Input Unit 84, and Output Unit 85, and a Communications Control Unit 86. These components are interconnected via a Bus. The Memory 82 and the Storage Unit 83 are the non-transitory computer readable recording mediums. The configuration of the Data Processing Hardware may properly, without being limited to the example illustrated in FIG. 7, omit, replace and add the components.

The Processor 81 loads programs stored on the recording medium into a working area of the Memory 82, and the configuration units are controlled through running the programs, thereby enabling the Data Processing Hardware 80 to attain functions matching with predetermined purposes.

The Processor 81 is instanced by Central Processing Unit and a Digital Signal Processor.

The Memory 82 includes, e.g., the RAM and the ROM. The Memory 82 is also called a main storage device.

The Storage Unit 83 is instanced by EEPROM, the HDD and the SDD. The Storage Unit 83 may include a removal medium, i.e., a portable recording medium. The removable medium is a disc recording medium exemplified by a Universal Serial Bus memory or a Compact Disc (CD) and a Digital Versatile Disc (DVD). The Storage Unit 83 is also called a secondary storage device.

The Storage Unit 83 stores various categories of programs, various items of data and various types of tables on the recording medium in a readable/writable manner. The OS, the various categories of programs, and the various types of tables are stored in the Storage Unit 83. Information to be stored in the Storage Unit 83 may also be stored in the Memory 82. Information to be stored in the Memory 82 may also be stored in the Storage Unit 83.

The OS is software operating as an intermediary between the software and the hardware, and for managing a memory space, files, processes and tasks. The OS includes a communication interface. The communication interface is a program for transmitting and receiving the data to and from other external devices connected via the Communication Control Unit 86. The external devices embrace, e.g., other information processing apparatuses, external storage devices and other equivalent devices.

The Input Unit 84 includes a keyboard, a pointing device, a wireless remote controller, a touch panel and other equivalent devices. The Input Unit 84 may also include a video/image input device instanced by a camera and/or a voice/sound input device instanced by a microphone.

The Output Unit 85 includes a display device instanced by a Cathode Ray Tube display, a Liquid Crystal Display, a Plasma Display Panel and an Electroluminescence panel, and an output device instanced by a printer. The Output Unit 95 may also include a voice/sound output device instanced by a loudspeaker.

The Communication Control Unit 86 establishes connections to other apparatuses and controls communications between the Data Processing Hardware 80 and other apparatuses. The Communication Control Unit 86 is instanced by a Local Area Network (LAN) interface board and a wireless communication circuit for wireless communications. The LAN interface board and the wireless communication circuit are connected to a network exemplified by the Internet.

Processors load programs stored in the secondary storage devices into the main storage devices and run the programs, whereby computers, which attain the Control Device 20, the Terminal 30, the Server 40 and the Terminal 50, implement respective functions. The storage units of the respective devices are provided in storage areas of the main storage devices or the secondary storage devices.

### Operational Example

«Data Relay Apparatus Operational Sequence»

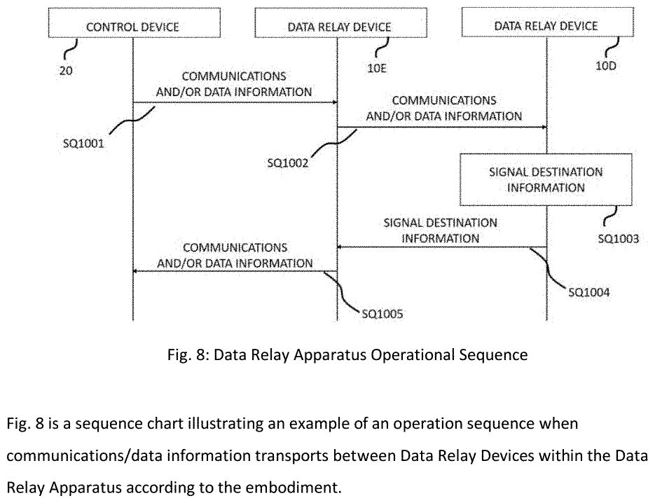

FIG. 8 is a sequence chart illustrating an example of an operation sequence when communications and/or data information transports from Data Relay Devices within the Data Relay Apparatus according to the embodiment. Herein, the Control Device 20 manages the performance of the Data Relay Devices 10 in the Data Relay Apparatus as depicted in FIG. 1. Each of the Data Relay Devices configuring the Data Relay Apparatus is installed in a predetermined location within the Solar System region. All of the Data Relay Devices 10 are installed in positions enabling the communications with any other Data Relay Devices 10. At least one of the Data Relay Devices 10 is installed in a position enabling notification to the Control Device 20. The Terminal 30 is to exist in a position enabling the Terminal 30 to receive the communications and/or data information from at least one of the Data Relay Devices 10.

In SQ1001, the Control Device 20 transmits a signal containing communications and/or data information toward the Data Relay Devices 10 configuring the Data Relay Apparatus including the Data Relay Device 10D. This signal is, e.g., a broadcast signal. The signal to be transmitted from the Control Device 20 may also be a predetermined data signal. The signal contains the identifying information for identifying Data Relay Device 10D. The signal sent from the Control Device 20 is receivable by the plurality of Data Relay Devices 10. Herein, the signal from the Control Device 20 is to be received by the Data Relay Device 10E. The Control Device 20 may transmit the signal containing the data information on the basis of a predetermined schedule.

The Data Relay Device 10E receiving the signal from the Control Device 20 checks a content of the signal. The Data Relay Device 10E checks whether the information contained in the received signal contains self-identifying information. An assumption herein is that this signal does not contain the identifying information of the Data Relay Device 10E. The Data Relay Device 10E stores the information contained in the received signal in the Storage Unit 13.

In SQ1002, the Data Relay Device 10E transmits the signal sent from the Control Device 20 toward the peripheral Data Relay Devices 10. When the signal sent from the Control Device 20 is the same as the signal transmitted before, the Data Relay Device 10E does not transmit this signal. Herein, this signal is to be received by the Data Relay Device 10D.

The Data Relay Device 10D receiving the signal from the Data Relay Device 10E checks a content of the signal. The Data Relay Device 10D checks whether the information contained in the received signal contains the self-identifying information. An assumption herein is that this signal contains the identifying information of the Data Relay Device 10D. The Data Relay Device 10D stores the information contained in the received signal in the Storage Unit 13.

In SQ1003, the Data Relay Device 10D, when recognizing that the receive signal contains the data information, checks the Signal Destination Route instructions contained in the received signal. The Signal Destination Route instructions are recognized by the Data Relay Device 10, based on a bit value of a predetermined position within the signal, which is previously settled between the Control Device 20 and each of the Data Relay Devices 10.

In SQ1004, the Data Relay Device 10D transmits the signal containing Signal Destination Route instructions toward the Control Device 20. The signal described above is, e.g., the broadcast signal. The signal may contain the identifying information for identifying the Control Device 20 as information specifying the Control Device 20 as a destination. The signal may also contain the Signal Destination Route instruction identifying the Control Device 20 as information specifying the Data Relay Device 10D as a transmission source of the signal. The Signal Destination Route instruction is expressed by the bit value of the predetermined position within the signal, which is previously settled between the Control Device 20 and each of the Data Relay Devices 10. Herein, the signal is to be received by the Data Relay Device 10E.

The Data Relay Device 10E receiving the signal from the Data Relay Device 10D checks a content of the signal. The Data Relay Device 10E checks whether the information contained in the received signal contains self-identifying-information and the Signal Destination Route instruction. An assumption herein is that this signal does not contain the identifying information of the Data Relay Device 10E. The Data Relay Device 10E stores the information contained in the received signal in the Storage Unit 13.

In SQ1005, the Data Relay Device 10E transmits the signal sent from the Data Relay Device 10D toward the peripheral Data Relay Devices 10. When the signal sent from the Data Relay Device 10D is the same as the signal transmitted before, the Data Relay Device 10E does not transmit this signal. Herein, this signal is to be received by the Control Device 20.

The Control Device 20 receiving the signal from the Data Relay Device 10E checks the content of the signal. The Control Device 20 checks whether the information contained in the received signal contains the self-identifying information. An assumption herein is that this signal contains the identifying information of the Control Device 20. The Control Device 20 stores the information contained in the received signal in the Storage Unit 23.

The Control Device 20 checks the information contained in the signal received from the Data Relay Device 10E. This information enables the Control Device 20 to recognize the Signal Destination Route instruction with respect to information processing protocols established for the Data Relay Device 10D.

The Control Device 20 is enabled to change the Signal Destination Route instruction for the Data Relay Device 10D by employing the data signal process used in Mesh Network communications. It is feasible for the Control Device 20 to change the destination result of a signal of data information by receiving the change in Signal Destination Route instruction from the Data Relay Device 10D. For example, when sending an ACK (ACKnowledge)/retransmission request as in the case of Three-Way Handshaking in Transmission Control Protocol, a packet is accurately transmitted and received, whereby it is possible to check whether the Signal Destination Route instruction is changed, in which case, however, this leads to an increase in number of packets, and communication efficiency typically decreases. Herein this embodiment, the data signal used in the Mesh Network communications is employed in the Data Relay Apparatus, and the Control Device 20 is thereby enabled to recognize the Signal Destination Route instruction change result while restraining a rise in signal quantity.

<Data Relay Apparatus Operation Creates Self-Forming and Self-Healing Mesh Network>

The Data Relay Device 10 in the Data Relay Apparatus according to the embodiment receives the signal containing the Signal Destination Route instruction from the Control Device 20. The Data Relay Device 10 changes the destination result of a signal of data information in accordance with the information processing protocols established for the Data Relay Device and Data Relay Apparatus. The Data Relay Apparatus 10 transmits the signal containing the Signal Destination Route instruction toward the Control Device 20. The Data Relay Device 10 uses the Data Information Packet for the self-forming, self-healing and self-expanding Mesh Network in the Data Relay Apparatus and is enabled to transmit the data information in accordance with the Signal Destination Route instruction.

«Cloud Computing Pattern»

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogenous thin or thick client platforms (e.g., mobile phones, laptops, and personal digital assistants).

Resource pooling: the provider's computing resources are pooled to serve multiple consumers using a multi-tenant model, with different physical and virtual resources dramatically assigned and reassigned according to demand. There is a sense of location independence in that the consumer generally has no control or knowledge over the exact location of the provided resources but may be able to specify location at a higher level of abstraction (coordinate positions in Solar System, location on celestial body, or orbital position/path).

Rapid elasticity: capabilities can be rapidly and elastically provisioned, in some cases automatically, to quickly scale out and rapidly released to quickly scale in.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser. The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provide to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components.

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability.

A cloud computing environment is service oriented with a focus on statelessness, low coupling, modularity, and semantic interoperability. At the heart of cloud computing is an infrastructure comprising a network of interconnected nodes.

«Data Relay Apparatus Functional Abstraction Layers»

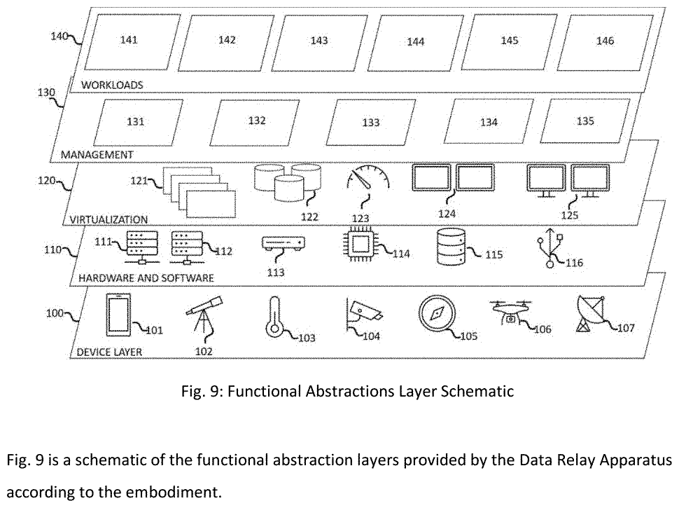

Referring now to FIG. 9, a set of functional abstraction layers provided by the Data Relay Apparatus is shown. It should be understood in advance that the components, layers, and functions shown in FIG. 9 are intended to be illustrative only and exemplary of the embodiment of the invention are not limited thereto.

Device Layer 100 includes physical and/or virtual devices, embedded with and/or standalone electronics, sensors, actuators, and other objects to perform various tasks in a Cloud Computing Environment (network) 1000 formed and sustained by the Data Relay Apparatus. Each of the devices in the Data Device Layer 100 incorporates networking capability to other functional abstraction layers such that data information obtained from the devices may be provided thereto, and/or information from the other abstraction layers may be provide to the devices. The various devices inclusive of the Device Layer 100 may incorporate a network of entities collectively known as the “internet of things” (IoT). Such a network of entities allows for intercommunication, collection, and dissemination of data to accomplish a great variety of purposes.

Device Layer 100 as shown includes Terminal 101, Sensor 102, Actuator 103, Camera 104, Navigation Controls 105, Propulsion and Altitude Controls 106, and Integrated Processing, Sensor and Networking Electronics 107 as shown. Other possible devices may include, but are not limited to various additional sensor devices, networking devices, electronics devices (such as a remote-control device), additional actuator devices, and a wide variety of other possible interconnected objects.

Hardware and Software Layer 110 includes hardware and software components. Examples of hardware components include: Mainframes 111; Reduced Instruction Set Computer Architecture Based Servers 112; Servers 113; Blade Servers 114; Storage Devices 115; and Networking Components 116. In some embodiments, software components include network application server software and database software.

Virtualization Layer 120 provides an abstraction layer from which the following examples of virtual entities may be provided: Virtual Servers 121; Virtual Storage 122; Virtual Networks 123, including virtual private networks; Virtual Applications and Operating Systems 124; and Virtual Clients 125.

Management Layer 130 may provide the functions described below. Resource Provisioning 131 provides dynamic procurement of computing resources and other resources that are utilized to perform tasks within the cloud computing environment. Metering and Pricing 132 provides cost tracking as resources are utilized within the cloud computing environment, and billing or invoicing for consumption of these resources. Security provides user verification for cloud consumers and tasks, as well as protection for data and other resources. User Portal 133 provides access to the cloud computing environment for consumers and system administrators. Service Level Management 134 provides cloud computing resource allocation and management such that required service levels are met. Service Level Agreement (SLA) Planning and Fulfillment 135 provides pre-arrangement for, and procurement of, cloud computing resources for which a future requirement is anticipated in accordance with an SLA.

Workloads Layer 140 provides examples of functionality for which the cloud computing environment may be utilized. Examples of workloads and functions which may be provided from this layer include: Mapping and Navigation 141; Software Development and Lifecycle Management 142; Virtual Classroom Education Delivery 143; Data Analytics Processing 144; Transaction Processing 145; and various Workloads and Functions 146 for selecting a communication service provider. In addition, Workloads and Functions 146 for selecting a communication provider may include such operations as data analysis (including data collection and processing from various environmental sensors), communication analysis, communication provider features and functionality analysis, and/or other functions relating to wireless communication. One of ordinary skill in the art will appreciate that the Workloads and Functions 146 for selecting a communication service provider may also work in conjunction with other portions of the various abstraction layers, such as those in Hardware and Software 110, Virtualization 120, Management 130, and other Workloads 140 (such as Data Analytics Processing 144, for example) to accomplish the various purposes of the illustrated embodiments of the present invention.

«Data Relay Apparatus Functional Components Mechanisms»

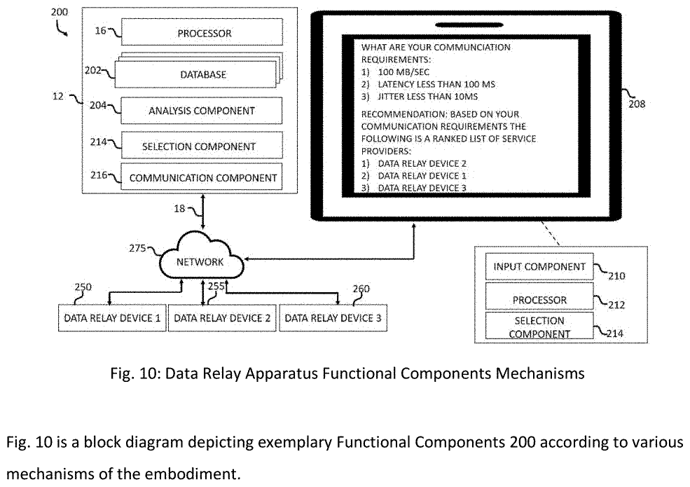

Turning now to FIG. 10, a block diagram depicting exemplary Functional Components 200 according to various mechanisms of the embodiment. In one aspect, each of the devices, components, modules, and/or functions described in FIGS. 8-9 may also apply to the devices, components, modules, and functions of FIG. 10. Also, one or more of the operations and steps of FIGS. 8-9 may also be included in one or more operations or actions of FIG. 10.

Computer System/Server 12 is shown, which may incorporate Processor 16 to perform various computational, data processing and other functionality in accordance with various aspects of the present invention. A Database 202 of application attributes/characteristics (e.g., a knowledge domain or ontology associated with application requirements, attributes, and/or characteristics) is shown, along with an Analysis Component 204, a Selection Component 214, and a Communication Component 216.

That is, application attributes/characteristics may be received or collected from each application associated with a UE such as, for example Computing Device 208 and stored/maintained in Database 202. The application attributes/characteristics may also be learned via a machine learning operation using the Analysis Component 204 in relation to Data Relay Apparatus provided by one or more Systems of Data Relay Devices such as, for example, Data Relay Device 250 (“Data Relay Device 1”), Data Relay Device 255 (“Data Relay Device 2”), and/or Data Relay Device 260 (“Data Relay Device 3”). The application attributes/characteristics may also be stored on the Computing Device 208 (in addition to Database 202), which may be associated with the central server, the cloud computing network, the local area network server, and/or the computing system of the IoT devices including an image capturing device.

FIG. 10's Functional Components 200 as shown may also include the Computing Device 208. In one aspect, the Computing Device 208 may be a tablet, computers, handheld devices, an IoT device, and the like. The Computing Device 208 may be connected via communications channels (e.g., Bus 18) through the Wireless Network 275 to the Computer System/Server 12 as shown. In the embodiment, the Computing Device 208 may connect through the Wireless Network 275 through the Internet to the Computer System/Server 12 to provide, send and/or receive information and/or instructions to and/or from the Computer System/Server 12. The Computing Device 208 may also connect through Wireless Network 275 through the Internet that may be provided by one or more communication paths such as, for example, Communication Path 1, Communication Path 2, and/or Communication Path 3. It should be noted that Computer System/Server 12 may be external to Computing Device 208 (e.g., provided via cloud computing) and/or may be installed internally on Computing Device 208.

The Computing Device 208 may incorporate additional Functional Components 200 such as, for example, the depicted Input Component 210, Processor 212, the Selection Component 214 (e.g., communication path/network component). Here again, the use of an Input Component 210 and Selection Component 214 are merely for illustrative convenience as a variety of functional components 200 may be integrated into the Computing Device 208 to accomplish specific functionality to further the mechanisms of the illustrated embodiment. The Computing Device 208 may provide an Interactive Graphical User Interface.

The Analysis Component 204 may analyze communication requirements for one or more applications of a UE to convey information over a communication network such as the Data Relay Apparatus. The Selection Component 214 select one of a plurality of Data Relay Devices within the Data Relay Apparatus (e.g., Data Relay Device 1, 2, and/or 3) matching both the communication requirements and one or more Signal Destination Route criteria. Each of the plurality of Data Relay Devices (e.g., Data Relay Devices 1, 2, and/or 3) capabilities may be tested and/or assessed using real-time testing of a communication link for the communication and routing requirements. Also, each of the plurality of communication paths capabilities may be assessed according to historical data.

The Selection Component 214 may select one of the plurality of Data Relay Devices matching the communication requirements below an electromagnetic wavelength propagation threshold. Also, the Analysis Component 204 may also define and/or analyze the one or more Signal Destination Route selection criteria to include an electromagnetic wavelength threshold and one or more required Data Relay Device capabilities. An electromagnetic wavelength threshold may be defined to be included in the one or more Signal Destination Route selection criteria. The Selection Component 214 may also rank each of the plurality of Data Relay Devices according to the one or more user selection criteria. For example, if a selected application of a UE is a media streaming application, the Selection Component 214 may rank the Data Relay Apparatus Communication Path 2 as being first (e.g., top ranked, top ranked, best, optimal, and/or having a highest-ranking score) that is a Signal Destination Route (Communication Path) that matches both the communication requirements and one or more Signal Destination Route selection criteria. Data Relay Apparatus Communication Path 1 may be ranked second behind Data Relay Apparatus Communication Path 2, and above Data Relay Apparatus Communication Path 3.

The Communication Component 216, in association with the Selection Component 214, may communicate and/or connect to the one or more Data Relay Devices upon selection one of the plurality of Data Relay Apparatus Communication Paths within the Data Relay Apparatus (e.g., Data Relay Apparatus Communication Path 1, Data Relay Apparatus Communication Path 2, and/or Data Relay Apparatus Communication Path 3 according to a level of matching both the communication requirements and one or more Signal Destination Route selection criteria.

«Signal Destination Route Determination Operation»

It should be noted that Signal Destination Route selection requirements may be defined as one of the following attributes: throughput, latency, jitter, minimum packet size, maximum packet size, signaling protocol, data protocol, or other defined communication protocols, standards, or attributes. Also, the amount of historical data to use for determination of Signal Destination Route selection requirements may be based on user discretion and/or availability. Also, determining the Signal Destination Route selection requirements may involve one or more mathematical operations (e.g., using addition, subtraction, division, multiplication, standard deviations, means, averages, percentages, statistical modeling using statistical distributions, by finding minimums, maximums or similar thresholds for combined variables, etc.).

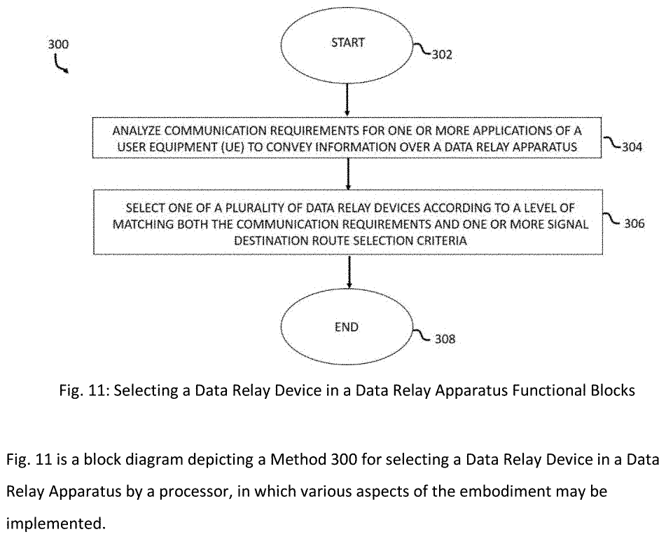

Turning now to FIG. 11, a Method 300 for selecting a Data Relay Device in a Data Relay Apparatus by a processor is depicted, in which various aspects of the embodiment may be implemented. The Functionality 300 may be implemented as a method executed as instructions on a machine, where the instructions are included on at least one computer readable medium or one non-transitory machine-readable storage medium. The Functionality 300 may start in Block 302.

Communication requirements for one or more applications of a UE may be analyzed to convey information over a Data Relay Apparatus, as in Block 304. A Data Relay Device may be selected according to a level of matching both the communication requirements and one or more Signal Destination Instruction selection criteria, as in Block 306. The Functionality 300 may end, as in Block 308.

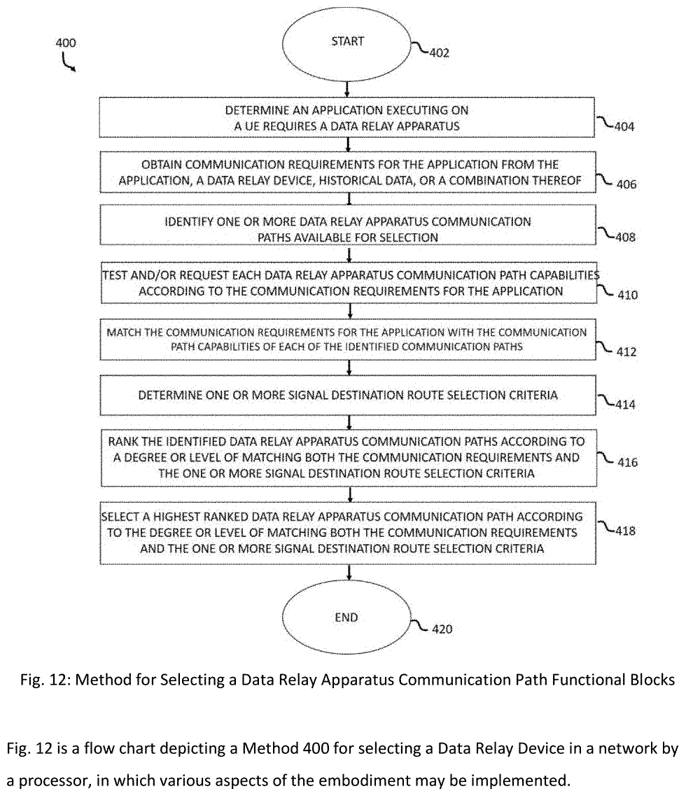

Turning now to FIG. 12, a Method 400 for selecting a communication path in an IoT network by a processor is depicted, in which various aspects of the embodiment may be implemented. That is, FIG. 12 is a flowchart of an additional example Method 600 for selecting a Data Relay Device in a Data Relay Apparatus according to an example of the present invention. The Functionality 400 may be implemented as a method executed as instructions on a machine, where the instructions are included on at least one computer readable medium or one non-transitory machine-readable storage medium. The Functionality 400 may start in Block 402.

An operation may be performed to determine that an application executing on a UE requires a communication network, as in Block 404. Communication requirements for the application may be obtained from the application, a user, historical data, or a combination thereof, as in Block 406. One or more Data Relay Devices available for selection may be identified, as in Block 408. Capabilities of each Data Relay Device may be tested and/or requested from the Data Relay Apparatus, as in Block 410. The communication requirements for the application may be matched with the Data Relay Device capabilities within the Data Relay Apparatus, as in Block 412. One or more Signal Destination Route selection criteria may be determined (if any), as in Block 414.

The identified Data Relay Apparatus Communication Paths may be ranked according to a degree or level of matching both the communication requirements and the one or more Signal Destination Route selection criteria, as in Block 416. The ranking may be according to a weighted numerical value, ranked according to a defined range, ranked according to a percentage value, or according to one or more defined thresholds to identify the degree or level of the matching. A highest ranked Signal Destination Route (as compared with the other identified Signal Destination Routes) may be selected according to the degree or level of matching both the communication requirements and the one or more Signal Destination Route selection criteria, as in Block 418. The Functionality 400 may end, as in Block 420.

In one aspect, in conjunction with and/or as part of at least one block of FIGS. 11 and/or 12, the operations of methods 300 and/or 400 may include each of the following. The operations of 300 and/or 400 may include accessing each of the plurality of Data Relay Device capabilities using real-time testing of a communication link for the communication requirements, and/or accessing each of the plurality of Data Relay Device capabilities according to historical data. The operations 300 and/or 400 may select one of the plurality of Data Relay Device capabilities matching the communication requirements below an electromagnetic wavelength propagation threshold. The one or more Signal Destination Route selection criteria may be defined to include an electromagnetic wavelength propagation threshold and one or more required Data Relay Device capabilities. Also, an electromagnetic wavelength threshold may be defined to be included in one or more Signal Destination Route selection criteria. The operations of 300 and/or 400 may rank each of the plurality of Data Relay Devices according to the one or more Signal Destination Route selection criteria, the communications requirements, or a combination thereof.

The Signal Destination Route determination process may result from a system, a method, and/or a computer program product. The computer program product may include a computer readable storage medium (or media) having computer readable program instructions thereon for causing a processor to carry out aspects of the Signal Destination Route determination.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an EEPROM or Flash memory, a static random access memory (SRAM), a portable CD read-only memory, a DVD, a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions describe herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in computer readable storage medium within the respective computing/processing device.

Computer readable program instructions for carrying out operations of the present invention may be assembler instructions, instruction-set-architecture instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a wide area network (WAN), or the connection may be made to an external computer. In some embodiments, electronic circuitry including, for example, programmable logic circuitry, field-programmable gate arrays, or programmable logic arrays may execute the computer readable program instructions by utilizing state information of the computer readable program instructions to personalize the electronic circuitry, in order to perform aspects of the Signal Destination Route determination process.

Aspects of the Signal Destination Route determination process are described herein with reference to flowchart illustrations and/or block diagrams of methods, apparatus (network of systems and devices), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can be direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

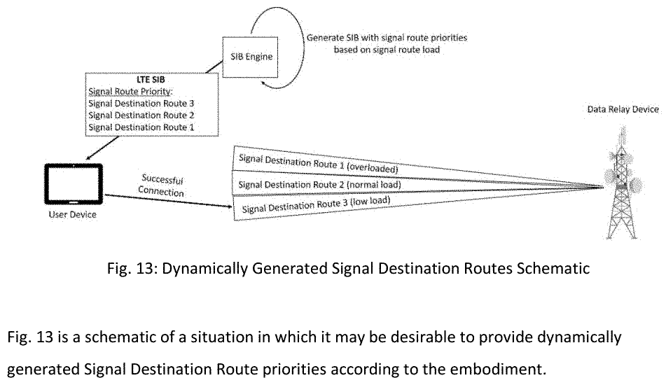

FIG. 13 illustrates an example situation in which it may be desirable to provide dynamically generated Signal Destination Route priorities. As shown, a Data Relay Device may be associated with multiple Signal Destination Routes (“Signal Destination Route 1,” “Signal Destination Route 2,” and “Signal Destination Route 3”). Signal Destination Route 1 may be overloaded (e.g., a large quantity of terminals and/or data relay devices may be connected to the Signal Destination Route 1), Signal Destination Route 2 may have a “normal” load (e.g., a quantity of terminals and/or data relay devices connected to the Signal Destination Route 2 may be within a “normal” range), and Signal Destination Route 3 may have a “low” measure of load (e.g., a quantity of terminals and/or data relay devices connected to the Signal Destination Route 3 may be below a range considered “normal”). As also shown, the terminal and/or data relay device may have received a System Information Block (“SIB”) that includes a prioritized list of Data Relay Devices associated with the Signal Destination Route. The SIB may indicate that Signal Destination Route 1 is the highest priority channel/route, then Signal Destination 2, and that Signal Destination Route 3 is the lowest priority channel/route.

Based on the SIB, the Data Relay Device may attempt (at arrow 1) to connect via Signal Destination Route 1. As shown in FIG. 13, the connection attempt may fail. For instance, the connection attempt may fail because Signal Destination Route 1 is overloaded (and, thus, the Data Relay Device may deny the connection request), because of poor RF conditions between the User Device and Signal Destination Route 1 (e.g., the end destination Data Relay Device may not receive the connection request), and/or for other reasons. Since Signal Destination Route 2 is indicated, in the SIB, as the next channel/route in the priority list, the User Device may attempt (at arrow 2) to connect via Signal Destination Route 2. As shown, the connection attempt may be successful.

At a later time, the User Device may attempt to reattach to the end destination Data Relay Device. The User Device may once again attempt (at arrow 3) to connect via Signal Destination Route 3, which is indicated in the SIB as being the highest priority carrier. As shown, this connection attempt may also fail, either for the same reasons or different reasons as the previous connection attempt (at arrow 1). Based on the failed connection attempt (at arrow 3), the terminal and/or data relay device may connect (at arrow 2) via Signal Destination Route 2.

FIG. 13 illustrates an example embodiment implementation in which SIBs may be dynamically generated based on signal destination route information. As shown, a SIB engine may generate a SIB based on Signal Destination Route load. For instance, the SIB may include a priority list that prioritizes the Signal Destination Routes in the following order: Signal Destination Route 3, Signal Destination Route 2, and Signal Destination Route 1. Based on the SIB, the terminals and/or Data Relay Devices may successfully connect via Signal Destination Route 3, without first attempting to connect via Signal Destination Route 1 and/or Signal Destination Route 2. Thus, time and/or network resources may be saved as compared to implementations in which the Data Relay Device first attempts to connect via Signal Destination Route 1 and/or Signal Destination Route 2. Further, the usage of Signal Destination Route 3, as opposed to more loaded Signal Destination Routes 1 and 2, may be beneficial for network performance.

Furthermore, since the SIB itself is being dynamically generated, logic of the Data Relay Device need not be changed, in order to implement techniques described herein.

«Signal Route Determination Configuration»

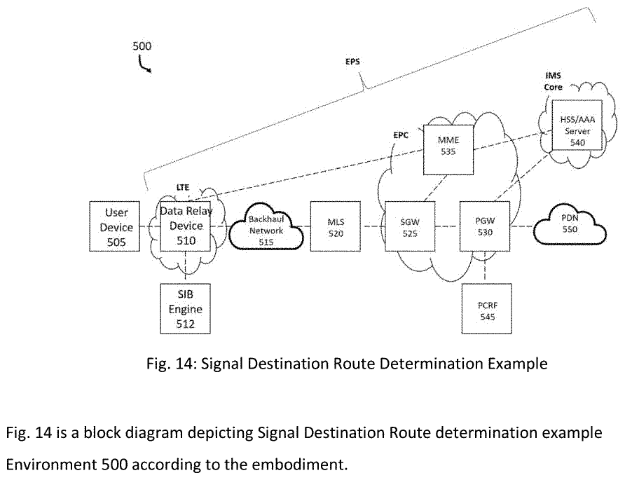

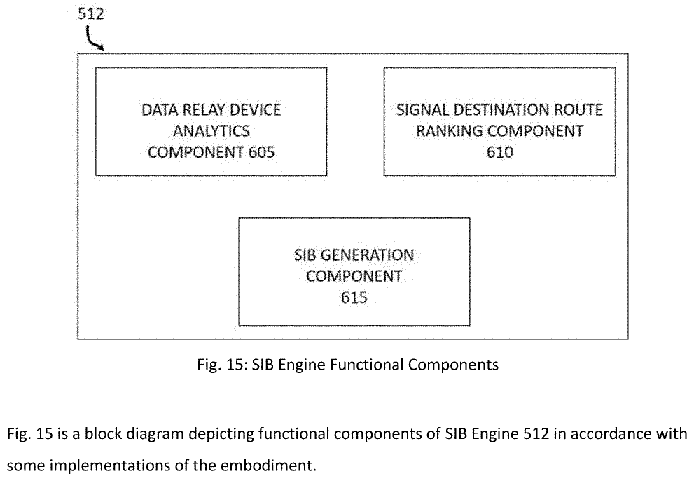

FIG. 14 illustrates example Environment 500, respectively, in which systems and/or methods described herein may be implemented. As shown in FIG. 15 Environment 500 may include User Device 505, Data Relay Device 510, SIB Engine 512, Backhaul Network 515, Multi-Layer switch (“MLS”) 520, Serving Gateway (“SGW”) 525, Packet Data Network (“PDN”) Gateway (“PGW”) 530, Mobility Management Entity (“MME”) Device 535, Home Subscriber Server (“HS S”)/Authentication, Authorization, Accounting (“AAA”) Server 540 (hereinafter referred to as “HSS/AAA Server 540”), Policy and Charging Rules Function (“PCRF”) 545, and PDN 550.

Environment 500 may include an Evolved Packet System (“EPS”) that includes a long-term evolution (“LTE”) network and/or an Evolved Packet Core (“EPC”) network. The LTE network may be, or may include, a radio access network (“RAN”) that includes one or more base stations 510, some or all of which may take the form of an evolved node B (“eNB”), via which User Device 505 may communicate with the EPC network. The EPC network may include one or more SGWs 525, PGWs 530, and/or MMEs 535, and may enable User Device 505 to communicate with PDN 550 and/or an Internet Protocol (“IP”) multimedia subsystem (“IMS”) core network. The IMS core network may include HSS/AAA Server 540, and may manage authentication, session initiation, account information, a user profile, etc., associated with User Device 505.

User Device 505 may include any computation and communication device, such as a wireless mobile communication device that is capable of communicating with Data Relay Device 510 and/or PDN 550. User Device 505 may send traffic to and/or receive traffic from PDN 550 via Data Relay Device 510, Backhaul Network 515, MLS 520, SGW 525, and/or PGW 530.

Data Relay Device 510 may include one or more network devices that receive, process, and/or transmit traffic, such as calls, audio, video, text, and/or other data, destined for and/or received from User Device 505. In one example, Data Relay Device 510 may be an eNB device and may be part of the LTE network. Additionally, or alternatively, one or more Data Relay Devices 510 may be associated with a RAN that is not associated with the LTE network. Data Relay Device 510 may receive traffic from and/or send traffic to User Device 505 via SGW 525, PGW 530, and/or PDN 550. Data Relay Device 510 may send traffic to and/or receive traffic from User Device 505.

Data Relay Device 510 may be associated with one or more Data Relay Systems. The different Data Relay Devices may each be associated with a particular Signal Destination Route, or more than one Data Relay Device may be associated with a Signal Destination Route. For example, one or more Data Relay Devices may be associated with a SHF Signal Destination Route, while one or more Data Relay Devices of the Data Relay Apparatus may be associated with a UHF Signal Destination Route. As another example, one System of Data Relay Devices, of the Data Relay Apparatus, may be associated with a 700 MHz band, while another System of Data Relay Devices may be associated with a 1700 MHz band. As yet another example, one System of Data Relay Devices may be associated with one sub-band of a particular RF band, while another System of Data Relay Devices may be associated with a different sub-band, of the particular RF band.

SIB Engine 512 may include one or more Data Relay Devices that dynamically generate SIBs, in accordance with implementations described herein. SIB Engine 512 may be deployed on a per Data Relay Device basis (e.g., one SIB Engine 512 per Data Relay Device 510), on a per-system basis (e.g., one SIB Engine 512 per System of Data Relay Devices, associated with a particular Data Relay Device(s) 510), or on another basis (e.g., one SIB Engine 512 for multiple systems, or one SIB Engine 512 for multiple Data Relay Devices 510). In some implementations, some functionality of SIB Engine 512 may be deployed more granularly than other functionality of SIB Engine 512. For example, as described below, SIB Engine 512 may generate SIBs on a per-Data Relay Device basis, and may receive and store information regarding more than one Data Relay Device. That is SIB Engine 512 may generate SIBs, for a particular Data Relay Device, based on analytics information regarding the particular Data Relay Device and/or one or more Data Relay Devices (e.g., Data Relay Devices as part of a System).

Backhaul Network 515 may include one or more network devices (e.g., routers and/or switches) and links (e.g., fiber or coaxial links), that connect Data Relay Device 510 to a core network (e.g., a core network that includes and/or is associated with MLS 520, SGW 525, and/or PGW 530).

MLS 520 may include one or more network devices that perform switching functionality on traffic received from SGW 525 and/or Backhaul Network 515. MLS 520 may operate multiple layers of the Open Systems Interconnection reference model, in contrast with other types of switches that traditionally operate only on the Data Link Layer. For example, MLS 520 may perform deep packet inspection to perform routing functions.

SGW 525 may include one or more network devices that gather, process, search, store, and/or provide information in a manner described herein. SGW 525 may, for example, aggregate traffic received from one or more Data Relay Devices 510 and may send the aggregated traffic to PDN 550 via PGW 530.

PGW 530 may include one or more network devices that gather, process, search, store, and/or provide information in a manner described herein. PGW 530 may aggregate traffic received from one or more SGWs 525, etc. and may send the aggregated traffic to PDN 550. PGW 530 may also, or alternatively, receive traffic from PDN 550 and may send the traffic toward User Device 305 via Data Relay Device 510, and/or SGW 525.

MME 535 may include one or more computation and communications devices that perform operations to register User Device 505 with the EPS, to establish bearer channels associated with a session with User Device 505, to hand off User Device 505 from the EPS to another network, to hand off User Device 505 from the other network to the EPS, and/or to perform other operations. MME 535 may perform policing operations on traffic destinations for and/or received from User Device 505.

HSS/AAA Server 540 may include one or more devices that manage, update, and/or store, in a memory associated with HSS/AAA Server 540, profile information associated with a subscriber. The profile information may identify applications and/or services that are permitted for and/or accessible by the subscriber; bandwidth or data rate thresholds associated with the applications and/or services; information regarding services to which subscribers are subscribed (e.g., communication services, such as video conferencing services, voice chat services, etc.); and/or other information. Additionally, or alternatively, HSS/AAA Server 540 may perform authentication, authorization, and/or accounting operations associated with the subscriber and/or a communication session with User Device 505.

PCRF 545 may include one or more devices that aggregate information to and from the EPC network and/or other sources. PCRF 545 may receive information regarding policies and/or subscriptions from one or more sources, such as subscriber databases and/or from one or more users (such as, for example, an administrator associated with PCRF 545).

PDN 550 may include one or more wired and/or wireless networks. For example, PDN 550 may include an IP-based PDN, a WAN such as the Internet, a core network of a telecommunications provider, a private enterprise network, and/or one or more other networks. User Device 505 may connect, through PGW 530, to data servers, application servers, other User Devices 505 and/or to other servers or applications that are coupled to PDN 550. PDN 550 may be connected to one or more other networks.

FIG. 15 illustrates example functional components of SIB Engine 512, in accordance with some implementations. As shown, SIB Engine 512 may include Data Relay Device Analytics Component 605, Signal Destination Route Ranking Component 610, and SIB Generation Component 615. In other implementations, the SIB Engine 512 may include additional, fewer, different, and/or differently arranged modules. Further, the functionality of one module may be performed by one or more other modules. Also, the functionality of multiple modules may be performed by one module.

Signal Destination Route Analytics Component 605 may receive and/or store analytics information regarding one or more Systems of Data Relay Devices associated with Data Relay Device 510. For example, the Signal Destination Route analytics information may indicate how loaded the Data Relay Devices are, and may be on a per Data Relay Device basis. For instance, a particular Signal Destination Route may be loaded when a relatively large quantity of User Devices 505 are connected to Data Relay Device 510 via the Signal Destination Route. As another example, a measure of load may indicate how many resource blocks, associated with a particular Signal Destination Route have been utilized, and/or how many resource blocks are available. Data Relay Device Analytics Component 605 may receive analytics information regarding one Signal Destination Route (e.g., Data Relay Devices associated with the Data Relay Apparatus) or more than one System (e.g., Signal Destination Routes associated with two or more Data Relay Systems of Data Relay Devices). Data Relay Device Analytics Component 605 may receive the analytics information from Data Relay Device 510 and/or from another device (e.g., a device that communicates with one or more Data Relay Devices 510 in order to determine the analytics information).

The Data Relay Devices analytics information may be real time, or near-real time information. For example, Data Relay Devices Analytics Component 605 may receive up-to-date analytics information, as the information is collected or generated. In some implementations, the Data Relay Devices analytics information may include historical information (e.g., Data Relay Devices analytics information from the past hour, from the past day, from the past month, etc.). In some implementations, Data Relay Device Analytics Component 605 may maintain the information along with timestamp information, which may be used by, for example, Signal Destination Route Ranking Component 610. For example, Signal Destination Route Ranking Component 610 may rank Signal Destination Routes based on the Data Relay Device analytics information from the past hour, from the past day, etc. As another example, Signal Destination Route Ranking Component 610 may rank Signal Destination Routes based on time of day, day of week, season of the year, etc.

Signal Destination Route Ranking Component 610 may rank Signal Destination Routes, of a particular System of Data Relay Devices, based on the Data Relay Device analytics information for the particular system (e.g., information received and/or stored by a Data Relay Device Analytics Component 605). For instance, a Signal Destination Route that is relatively highly loaded may be ranked lower than a Signal Destination Route that is less loaded. In this manner, less loaded Signal Destination Routes may be prioritized over more loaded Signal Destination Routes, so that User Devices 505 attempt to connect via the less loaded Signal Destination Routes before attempting to connect via the more loaded Signal Destination Routes. In some implementations, Signal Destination Route Ranking Component 610 may rank Signal Destination Routes based on one or more other factors. For example, a Signal Destination Route may be weighted more heavily than another one, so that even if the particular Signal Destination Route is more heavily loaded than the other Signal Destination Route, the particular Signal Destination Route may be ranked higher than the other Signal Destination Route.

For example, a network administrator may weight a UHF Signal Destination Route more heavily than a SHF Signal Destination Route. If the UHF Signal Destination Route is not significantly (e.g., at least a threshold) more loaded than the SHF Signal Destination Route, Signal Destination Route Ranking Component 610 may not rank the SHF Signal Destination Route ahead of the UHF Signal Destination Route. On the other hand, if the UHF Signal Destination Route is significantly more loaded than the SHF Signal Destination Route, Signal Destination Route Ranking Component 610 may rank the SHF Signal Destination Route ahead of the UHF Signal Destination Route. As another example, a network administrator may weight a better performing Signal Destination Route over a worse performing Signal Destination Route (e.g., the better performing Signal Destination Route may provide for higher bandwidth communications, lower latency communications, larger coverage area, stronger coverage (e.g., higher signal-to-noise ratio), etc.).

SIB Generation Component 615 may generate SIBs based on the ranking performed by Signal Destination Route Ranking Component 610. In some implementations, SIB Generation Component 615 may generate a new SIB each time a new ranking is performed by Signal Destination Route Ranking Component 610. In other implementations, SIB Generation Component 615 may generate a SIB at other times. SIB Generation Component 615 may provide the generated SIBs to Data Relay Devices 510, which may output the SIBs to one or more User Devices 505.

As mentioned above, in some implementations, SIB Engine 512 may be associated with multiple Data Relay Devices. In some such implementations, SIB Engine 512 may include multiple instances of certain components described below. For instance, assume that SIB Engine 512 is associated with three Data Relay Devices. In this example, SIB Engine 512 may include one Data Relay Device Analytics Component 605, multiple (e.g., three) Signal Destination Route Ranking Components 610, and multiple (e.g., three) SIB Generation Components 615.

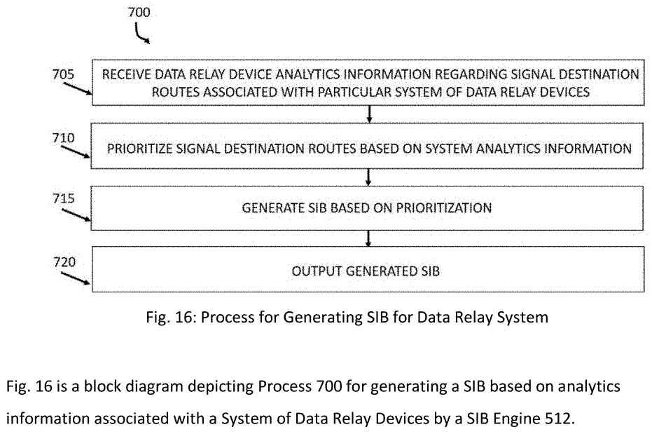

FIG. 16 illustrates an example process 700 for generating a SIB based on analytics information associated with a System of Data Relay Devices. In some implementations, process 700 may be performed by SIB Engine 512. In other implementations, some or all of process 700 may be performed by one or more other devices.

Process 700 may include receiving (at 705) Data Relay System analytics information regarding Signal Destination Routes associated with a particular System of Data Relay Devices. For example, as described above with respect to Data Relay System Analytics Component 705, SIB Engine 512 may receive Data Relay System analytics information, which may indicate, for example, load associated with Signal Destination Route of a particular System of Data Relay Devices. The analytics information may additionally, or alternatively, include other types of information, such as an average time of connections of User Devices 505 via the Signal Destination Routes.

Process 700 may also include prioritizing (at 710) Signal Destination Routes based on the Data Relay System analytics information. For instance, as described above with respect to Signal Destination Route Ranking Component 610, SIB Engine 512 may rank the Signal Destination Routes based on the analytics information and/or one or more other factors, such as weights associated with the Signal Destination Routes, a previous ranking of the Signal Destination Routes, etc.

Process 700 may further include generating (at 715) a SIB based on the prioritization, and outputting (at 720) the SIB. For example, as described above with respect to SIB Generation Component 715, SIB Engine 512 may generate a SIB, and may output the SIB to Data Relay Device 510. The SIB may be provided to one or more User Devices 505, and User Devices 505 may use the SIB to determine which Signal Destination Routes to attempt to attach to, and in which order to make the attempts.

As mentioned above, some or all of process 700 may be repeated in an iterative manner. For example, SIB Engine 512 may receive (at 705) Data Relay System analytics information on an ongoing basis, and may prioritize (at 710) Signal Destination Routes and dynamically generate (at 715) SIBs based on the Data Relay System analytics information that is received on an ongoing basis. Thus, at one particular time, the rankings in a particular SIB may be different from the rankings in another SIB generated at a subsequent time.

«Signal Destination Routing Operation Creates and Maintains Mesh Network»

The Mesh Network of some embodiments may be implemented with a custom self-forming, self-healing, and self-expanding Mesh Network algorithm. Each Data Relay Device in the Data Relay Apparatus may be able to generate messages, relay messages from other Data Relay Devices, and/or receive messages, subject to RF and/or optical laser link availability. The Data Relay Apparatus (network) may be self-forming in that each Data Relay Device (node) learns about the nearby nodes that can be used to relay messages to the final destination. A Data Relay Device may request routing information from its neighbors in order to discover more distant Data Relay Devices. The process of requesting routine information from neighbors may be repeated. Over time, all the potential Signal Destination Routes may be discovered. A Data Relay Device can appear only once in the Signal Destination Route in some embodiments. This prevents the formation of loops in the routing table.

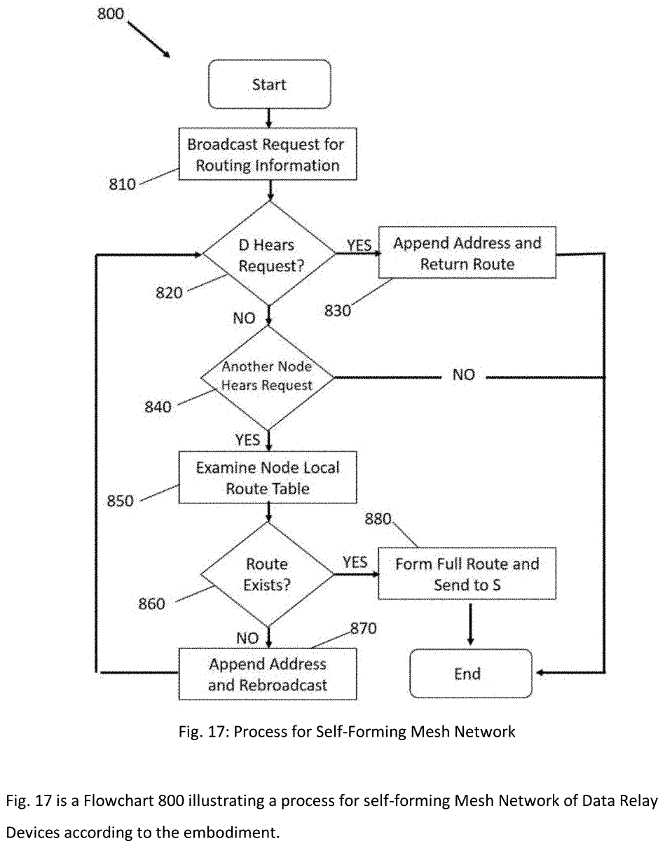

FIG. 17 is a Flowchart 800 illustrating a process for self-forming Mesh Network of Data Relay Devices according to the embodiment. The process begins with creating a route table by broadcasting a request for information from a source Data Relay Device (Start) to a particular destination Data Relay Device (End) at 810. The request carries along a candidate route that will be filled in by other Data Relay Devices. If the End Data Relay Device hears this request at 820, it responds by appending its address to the candidate route and returning the route to the source Data Relay Device in the form of a route response message at 830. The destination Data Relay Device may not have a pre-existing route to the starting Data Relay Device, but by reversing the candidate route in the route request, the destination Data Relay Device is guaranteed to be able to route a message back to the starting Data Relay Device.

If any other node (e.g., Data Relay Device X) hears the request at 840, Data Relay Device X examines its local route table for a route to the destination Data Relay Device at 850. If a route to the starting Data Relay Device exists at 860, the route from the route table is joined with the partial route in the incoming route request to make a full route from the starting Data Relay Device to the destination Data Relay Device via Destination Relay Device X, and the message is sent to the starting Data Relay Device at 880, which will add the information to its route table. As before, X may reverse the candidate route in the route request to guarantee being able to route the message back to the starting Data Relay Device. Otherwise, X will append its address to the candidate route in the route request message and re-broadcast the route request message at 870. The process then returns to step 820.

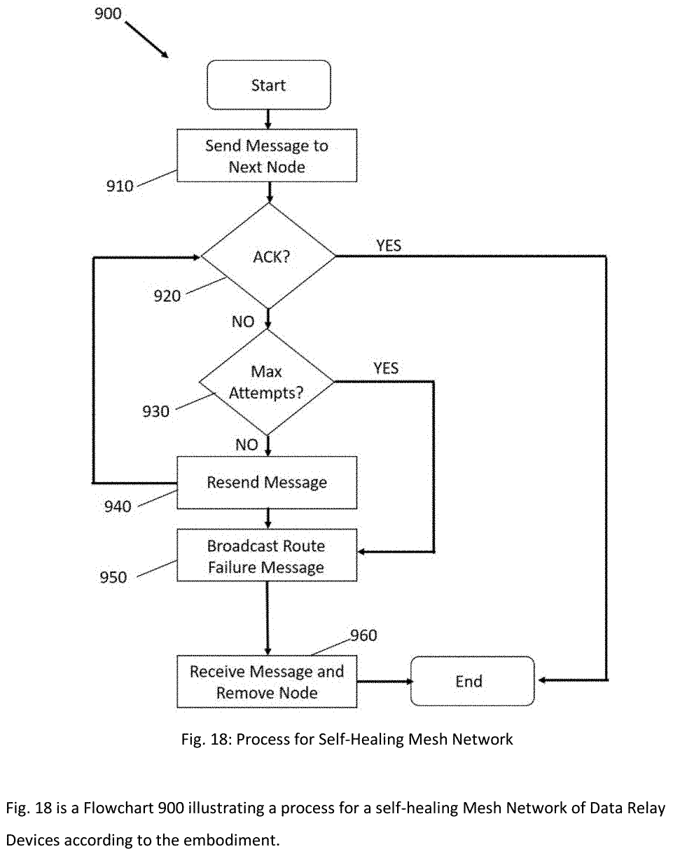

FIG. 18 is a Flowchart 900 illustrating a process for a self-healing Mesh Network of Data Relay Devices according to the embodiment. Each datagram message relay “hop” requires an explicit acknowledgement (ACK) from the next Data Relay Device (node) in the route in this embodiment. The process begins with sending a message to the next Data Relay Device (node) at 910. If an ACK response is received at 920, the process ends.

However, if the ACK response is not received at 920, a count of the number of attempted transmissions is incremented. If the count does not exceed a predetermined number of attempts at 930, the message is re-sent at 940, and the process returns to step 920. If a predetermined number of attempts to send the message is reached at 930 and no reply has been received within a predetermined amount of time, the transmission is abandoned (i.e., the message is discarded) and a route failure message is broadcast at 950. The failure message identifies the link that is no longer valid (e.g., from Data Relay Device X to the Destination Data Relay Device).

Upon receipt of a route failure message, each recipient Data Relay Device (node) examines the local route table for occurrences of the bad link, and any route containing that link is discarded at 960. Thus, the route failure message allows the Data Relay Apparatus (network) to notice failed or poor-quality network links and eliminate them from the route tables of the network nodes.

The network may be self-healing in that if an individual node fails, the absence of a message acknowledgment may be used to mark the Signal Destination Route between the transmitting Data Relay Device and the receiving Data Relay Device as no longer valid. The route failure message may then be broadcast to the remainder of the network and each Data Relay Device that receives the route failure message may remove the bad link from its routing information table. In this way, the loss of network connectivity may be noticed by the remainder of the network. If the node is later repaired, the route discovery process may notice the re-appearance of the node and add it to the route table.

New nodes may be added to the network at any time and begin participating in message routing and route discovery immediately in some embodiments. A new node may originate datagram traffic by generating route requests and discovering routes to various destinations. Joining the network may require the ability to response to route request messages. The new node may then start appearing in route tables.

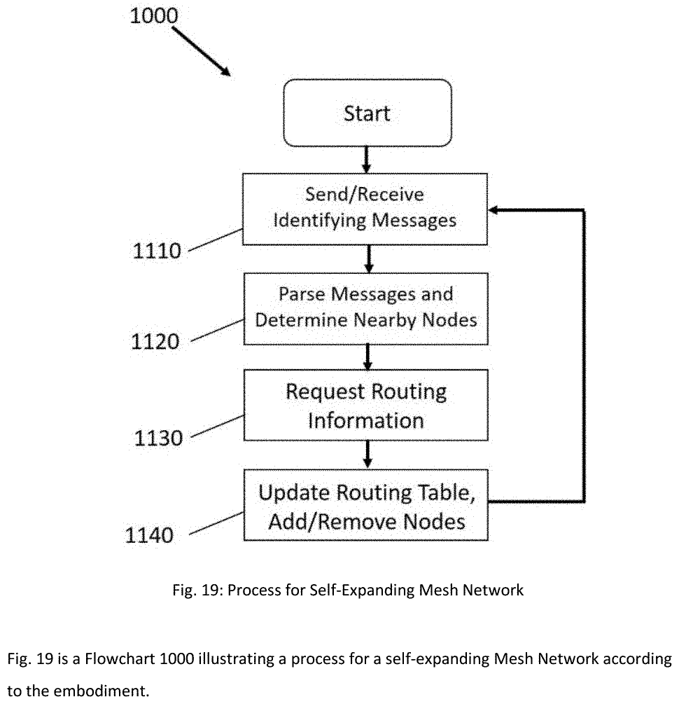

Such a process for self-expanding a Mesh Network is illustrated in Flowchart 1000 of FIG. 19. The process for a given link between Data Relay Devices begins with periodically sending messages containing identifying information to, and receiving such messages from, other Data Relay Devices in the Data Relay Apparatus that are within communications range at 1110. The information contained in these messages may include, but is not limited to, source (i.e., originating) Data Relay Device address, destination Data Relay Device address, the explicit route (i.e., a list of network nodes indicating the network path to use for this message), and/or a communication path index(ices) (i.e., a value indicating the active hop in the route). The communication path index(ices) may be used to identify the next hop that a message takes in transit. A Data Relay Device address of 255, for example, may be used to indicate a broadcast message. These messages may be acted upon by any Data Relay Device that receives them.

Next, the Data Relay Device parses received messages and determines nearby Data Relay Devices in range at 1120 that can be used to relay messages to a destination. The Data Relay Device then requests routing information from its neighbors to discover more distant Data Relay Devices at 1130. New nodes are added to the routing table at 1140. A message may be explicitly routed to its destination using one or more individual nodes as relays. Each message relay (i.e., a “hop”) may be explicitly acknowledged to ensure that the message is delivered. If the acknowledgement is not received, the transmitting node may re-send the message. If the number of re-transmissions exceeds an application-dependent threshold, the network link may be marked as failed and removed from the routing information table at 1140. The process may be repeated, returning to step 1110, until all potential Signal Destination Routes are discovered.

<Data Relay Apparatus Component Locations and Architecture Composition>

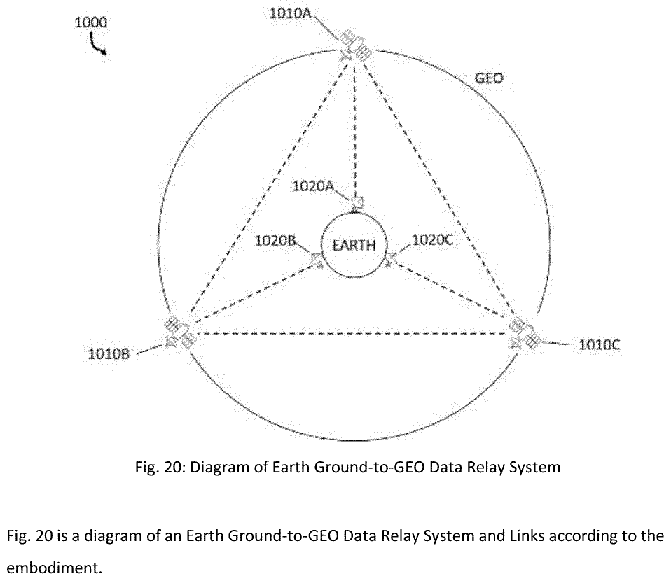

FIGS. 20-24 are diagrams of exemplary Systems of Data Relay Devices that comprise the Data Relay Apparatus throughout the Solar System Region. Each FIG. illustrates an example of a set of functional abstraction layers provided by the Data Relay Apparatus. It should be understood in advance that the components, layers, and functions shown in FIGS. 20-24 are intended to be illustrative only and exemplary of the embodiment of the invention are not limited thereto.

FIG. 20 is a diagram of an Earth Ground-to-GEO Data Relay System and Links according to the embodiment. The Data Relay System 1000 sends and receives data from and to Data Relay Devices 1020 located on the Earth's surface and Data Relay Devices 1010 located in GEO.

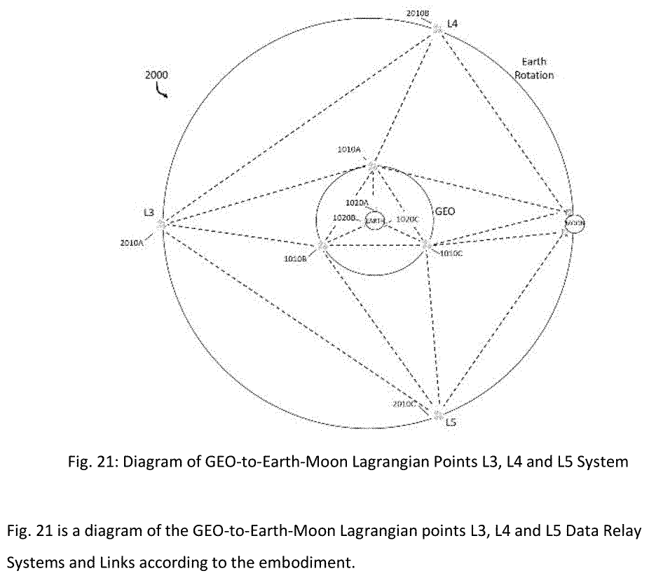

FIG. 21 is a diagram of the GEO-to-Earth-Moon Lagrangian points L3, L4 and L5 Systems and Links according to the embodiment. The Data Relay System 2000 sends and receives data from and to Data Relay Devices 1020 located on the Earth's surface and/or Data Relay Devices 1010 located in GEO and Data Relay Devices 2010 located at Earth-Moon Lagrangian points L3, L4 and L5.

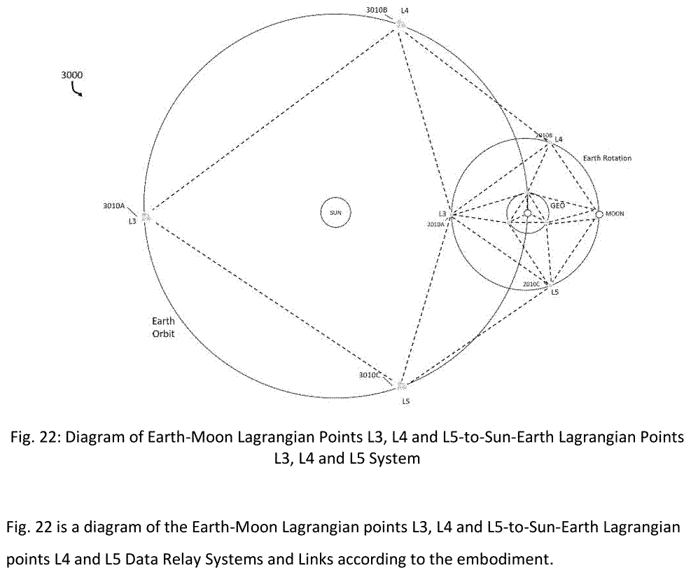

FIG. 22 is a diagram of the Earth-Moon Lagrangian points L3, L4 and L5-to-Sun-Earth Lagrangian points L4 and L5 Systems and Links according to the embodiment. The Data Relay System 3000 sends and receives data from and to Data Relay Devices 2010 located at Earth-Moon Lagrangian points L3, L4 and L5 and Data Relay Devices 3010 located at Sun-Earth Lagrange points L3, L4 and L5.

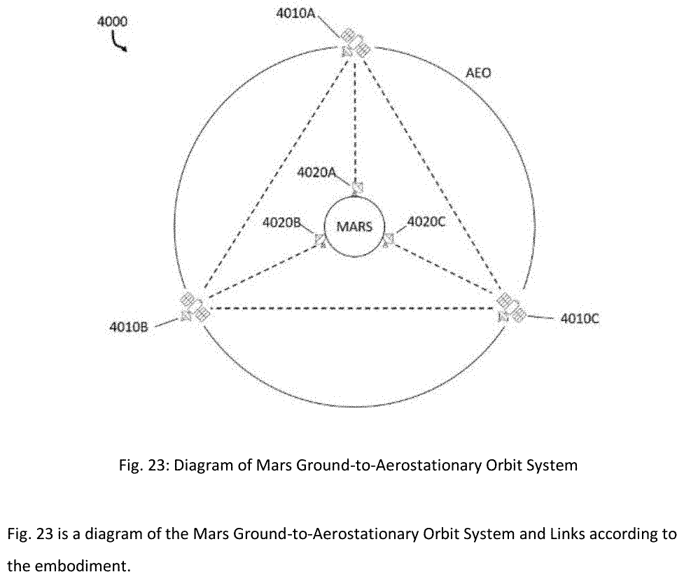

FIG. 23 is a diagram of the Mars Ground-to-AEO points Systems and Links according to the embodiment. The Data Relay System 4000 sends and receives data from and to Data Relay Devices 4020 located on the surface of Mars and Data Relay Devices 4010 located in AEO.

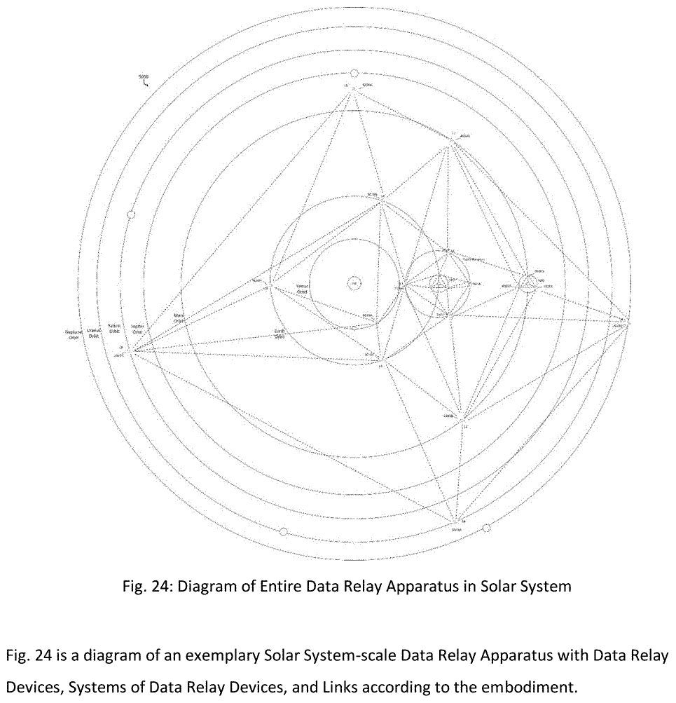

FIG. 24 is a schematic view of an exemplary Solar System-scale Data Relay Apparatus with Data Relay Devices, Systems and Links according to the embodiment. The Data Relay Apparatus 5000 consists of Systems of Data Relay Devices that send and receive data from and to Data Relay Devices 2010 located at Earth-Moon Lagrangian points L3, L4 and L5; Data Relay Devices 3010 located at Sun-Earth Lagrangian points L3, L4 and L5; Data Relay Devices 4010 located at Sun-Mars Lagrangian points L4 and L5; Data Relay Devices 5010 located at Sun-Venus Lagrangian point L4; Data Relay Device 5020 located at Sun-Jupiter Lagrangian point L1; Data Relay Device 5030 located at Sun-Saturn Lagrangian point L4; Data Relay Device 5040 located at Sun-Uranus Lagrangian point L4; and Data Relay Device 5050 located at Sun-Neptune Lagrangian point L4.

The flowcharts, diagrams and schematics in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, can be implemented by special purpose hardware-based systems that perform the specified functions or acts or carry out combinations of special purpose hardware and computer instructions.

### BRIEF DESCRIPTION OF REFERENCE NUMERALS AND SYMBOLS

10 Data Relay Device
11 Data Information Transmitting Unit
12 Mutual Communication Unit/Computer System Server
13 Storage Unit
18 Bus
20 Control Device
21 Relay Communications Unit
22 Information Acquiring Unit
23 Storage Unit
30 Terminal
31 Data Information Transmitting Unit
32 Mutual Communication Unit
33 Storage Unit
34 Display Unit
40 Server
41 Communications Unit
42 Arithmetic Unit
43 Storage Unit
50 Terminal
51 Communication Unit
52 Storage Unit
53 Display Unit
80 Data Processing Hardware
81 Processor
82 Memory
83 Storage Unit
84 Input Unit
85 Output Unit
86 Communications Control Unit
100 Device Layer
101 Terminal
102 Sensor
103 Actuator
104 Camera
105 Navigation Controls
106 Propulsion and Altitude Controls
107 Integrated Processing, Sensor and Networking Electronics
110 Hardware and Software Layer
111 Mainframes
112 Reduced Instruction Set Computer Architecture Based Servers
113 Servers
114 Blade Servers
115 Storage Devices
116 Networking Components
120 Virtualization Layer
121 Virtual Servers
122 Virtual Storage
123 Virtual Networks
124 Virtual Applications and Operating Systems
125 Virtual Clients
130 Management Layer
131 Resource Provisioning
132 Metering and Pricing
133 User Portal
134 Service Level Management
135 Service Level Agreement Planning and Fulfillment
140 Workloads Layer
141 Mapping and Navigation
142 Software Development and Lifecycle Management
143 Virtual Classroom Education Delivery
144 Data Analytics Processing
145 Transaction Processing
146 Workloads and Functions
200 Functional Components
202 Database
204 Analysis Component
208 Computing Device
210 Input Component
212 Processor
214 Selection Component
216 Communication Component
250 Data Relay Device 1
255 Data Relay Device 2
260 Data Relay Device 3
275 Wireless Network
300 Method for selecting Data Relay Device in a Data Relay Apparatus by a processor
302 Start Functionality 300
304 Block to analyze user equipment communication requirements
306 Block to select plurality of data relay devices
308 End Functionality 300
400 Method for selecting Data Relay Device in Data Relay Apparatus according to invention
402 Start Functionality 400
404 Determine application on user equipment requires Data Relay Apparatus
406 Obtain application communication requirements
408 Identify communication path(s)
410 Test and/or request communication path capabilities
412 Match application communication requirements with communication path(s) capabilities
414 Determine Signal Destination Route selection criteria
416 Rank communication paths based on Signal Destination Route selection criteria
418 Select highest ranked communication path by matching communication path(s) capabilities and Signal Destination Route selection criteria
420 End Function 400
500 Environment of Determining Signal Destination Routes
505 User Device
510 Data Relay Device
512 SIB Engine
515 Backhaul Network
520 Multi-Layer Switch
525 Serving Gateway
530 Packet Data Network Gateway
535 Mobility Management Entity Device
540 Home Subscriber Server/Authentication, Authorization, Accounting Server
545 Policy and Charging Rules Function
550 Packet Data Network
605 Data Relay Device Analytics Component
610 Signal Destination Route Ranking Component
615 SIB Generation Component
700 Process for generating SIB based on System of Data Relay Devices analytics information
705 Receive Data Relay Device analytics information regarding Signal Destination Routes
710 Prioritize Signal Destination Routes based on System of Data Relay Devices analytics information
715 Generate SIB based on prioritization
720 Output Generated SIB
800 Flowchart of self-forming Mesh Network of Data Relay Devices process
810 Starting Data Relay Device broadcasts request for routing information
820 Destination Data Relay Device determines whether it hears broadcast
830 Destination Data Relay Device appends address and returns route
840 Intermittent Data Relay Device determines whether it hears broadcast
850 Intermittent Data Relay Device examines route table for path to Destination Data Relay Device
860 Intermittent Data Relay Device determines path exists to Destination Data Relay Device
870 Intermittent Data Relay Device informs Starting Data Relay Device no path exists by appending address and returns route
880 Intermittent Data Relay Device informs Starting Data Relay Device that a path exists and sends full route to Starting Data Relay Device
900 Flowchart of self-healing Mesh Network of Data Relay Devices process
910 Data Relay Device (node) sends message to next/nearby Data Relay Device (node)
920 Data Relay Device receiving message sends Acknowledgement and process concludes (link formed)
930 Transmitting Data Relay Device determines whether a predetermined number of attempts to transmit and receive message has been met
940 Transmitting Data Relay Device resends message if the predetermined number of attempts does not meet limit
950 Transmitting Data Relay Device broadcasts route failure message to the Data Relay Apparatus if the predetermined number of attempts meets the limit
960 Each Data Relay Device (node) in the Data Relay Apparatus (network) examines the local route table for occurrence of the bad link and discards
1000 Data Relay Apparatus/Network/Flowchart of expanding Mesh Network of Data Relay Devices process
1010 Data Relay Devices located in GEO
1020 Data Relay Devices located on Earth's Surface
1110 Data Relay Devices periodically send self-identifying information to and from other Data Relay Devices
1120 Data Relay Device parses received messages and determines nearby Data Relay Devices
1130 Data Relay Device requests routing information from its neighbors to discover more distant Data Relay Devices
1140 New Data Relay Devices (nodes) in the Data Relay Apparatus (network) are added to the routing table or discarded if failed
2000 System of Data Relay Devices
2010 Data Relay Devices located at Earth-Moon Lagrangian points L3, L4 and L5
3000 System of Data Relay Devices
3010 Data Relay Devices located at Sun-Earth Lagrangian points L3, L4 and L5
4000 System of Data Relay Devices
4010 Data Relay Devices located in AEO
4020 Data Relay Devices located on the surface of Mars
5000 Data Relay Apparatus
5010 Data Relay Devices located at Sun-Venus Lagrangian point L4
5020 Data Relay Devices located at Sun-Jupiter Lagrangian point L1
5030 Data Relay Devices located at Sun-Saturn Lagrangian point L4
5040 Data Relay Devices located at Sun-Uranus Lagrangian point L4
5050 Data Relay Devices located at Sun-Neptune Lagrangian point L4

What is claimed is:

1. A Data Relay Apparatus comprising: System(s) of multi-band data information distribution devices (“Data Relay Devices”) with multiple electromagnetic wave frequency band (“Multi-Band”) transceiver/transceiver array operating interconnectedly to establish and maintain a point-to-multipoint (“Mesh Network”) throughout the Solar System region.

2. The method of claim 1, further comprising: Data Relay Devices includes one, but not limited to one, Multi-Band capable transceiver/transceiver array.

3. The functionality of claim 2, further comprising: Multi-Band capable transceivers/transceiver array(s) using the following Multi-Bands: Super High Frequency (SHF) (S-, C-, X-, Ku-, and Ka-bands), Ultra High Frequency (UHF), and/or Laser Optical.

4. The functionality of claim 2, further comprising: Multi-Band transceiver/transceiver array(s) using at least one, but not limited to one, omnidirectional antenna, steerable antenna and/or antenna array (“Mutual Communication Unit”).

5. The method of claim 1, further comprising: A Data Relay Apparatus operating as a self-forming, self-healing, and self-expanding Mesh Network.

6. The functionality of claim 5, further comprising: Determination, at Data Processing Hardware, a routing path of data information from a transmitting Data Relay Device to a receiving Data Relay Device through an Apparatus of Data Relay Devices and/or System(s) of Data Relay Device(s).

7. The functionality of claim 5, further comprising: Instructing, by the Data Processing Hardware, the transmitting Data Relay Device(s) to send data information to the receiving Data Relay Device(s) along the determined routing path through an apparatus of Data Relay Devices and/or System(s) of Data Relay Device(s).

8. The functional arrangement of claim 5, further comprising: At least one, but not limited to one, data information link between a transmitting Data Relay Device(s) and a receiving Data Relay Device(s) that are in the same System(s) of Data Relay Device(s).

9. The functional arrangement of claim 5, further comprising: At least one, but not limited to one, communications link between a transmitting Data Relay Device(s) and a receiving Data Relay Device(s) that are in different System(s) of Data Relay Device(s).

10. The functionality of claim 5, further comprising: Creating, by a self-forming Mesh Network, routing paths used to relay data information from transmission point to a destination point.

11. The functional arrangement of claim 5, further comprising: At least one, but not limited to one, Multi-Band transceiver/transceiver array using at least one, but not limited to one, omnidirectional antenna, steerable antenna and/or antenna array.

12. The functional arrangement of claim 5, further comprising: At least one, but not limited to one, Data Processor configured to perform scientific or algorithmic computing.

13. The functional arrangement of claim 5, further comprising: A data information path index(ices) identifying communication paths throughout the Data Relay Apparatus.

14. The functionality of claim 5, further comprising: Repairing, by a self-healing Mesh Network, routing paths used to relay data information from a transmission point to a destination point.

15. The functionality of claim 5, further comprising: Adaptability, by a self-expanding Mesh Network, routing paths used to relay data information from a transmission point to a destination point.

16. The functional arrangement of claim 5, further comprising: A ranked/prioritized index(ices) identifying data information paths based on a scoring function.

17. The functional arrangement of claim 5, further comprising: A scoring function for the following informational attributes: distance between transmission and receiving points, transceiver capacity, signal strength, and/or active status of Data Relay Device(s) components.
